(19) United States
(12) Patent Application Publication
(10) Pub. No.: US 2002/0131170 A1
(43) Pub. Date: Sep. 19, 2002

(54) Stereoscopic aperture valves

(76) Inventor: Bryan Costales, Boulder, CO (US)

Correspondence Address: SHERIDAN ROSS PC, 1560 BROADWAY, SUITE 1200, DENVER, CO, 80202

(21) Appl. No.: 10/044,146

(22) Filed: Jan. 11, 2002

Related U.S. Application Data
(60) Provisional application No. 60/261,236, filed on Jan. 12, 2001.
(60) Provisional application No. 60/324,206, filed on Sep. 21, 2001.
(60) Provisional application No. 60/283,505, filed on Apr. 11, 2001.
(60) Provisional application No. 60/308,515, filed on Jul. 26, 2001.
(60) Provisional application No. 60/277,323, filed on Mar. 20, 2001.

(51) Int. Cl. G02B 27/22

(52) U.S. Cl. 359/464; 359/462

(57) ABSTRACT

The present invention is directed to optical systems and aperture valves for producing stereoscopic images and to digital irises. One embodiment of the invention provides an optical system that has two of two-dimensional, three-dimensional, and inverse three-dimensional modes. Another embodiment provides a light valve using a plurality of regions of differing optical transmissivities. Another embodiment provides an optical system using a leading and/or analyzing filter that encodes only a portion of the light encoded by an encoder positioned at the aperture stop or conjugate thereof. Another embodiment provides a digital iris which includes a plurality of independently controllable pixels. Each pixel, for example, can include an active optical material, such as a liquid crystal material, and electrical conductors to apply a voltage across the material. The pixel alternates between transmissive and occlusive states.

### CROSS REFERENCE TO RELATED APPLICATIONS

The present application claims the benefits under 35 U.S.C. §119 of U.S. Provisional Applications Serial No. 60/261,236, filed Jan. 12, 2001, entitled “Single Lens Stereoscopic Methods and Apparatuses” to Costales, Serial No. 60/324,206, filed Sep. 21, 2001, entitled “Improved Stereoscopic Liquid-Crystal Light-Valve” to Costales, Serial No. 60/283,505, filed Apr. 11, 2001, entitled “Stereoscopic Quarter-Wave Retarder Light-Valve” to Costales, Serial No.60/308,515, filed Jul. 26, 2001, entitled “Stereoscopic Liquid-Crystal Light-Valve” to Costales, and Serial No. 60/277,323, filed Mar. 20, 2001, entitled “Single Lens Stereoscopic Methods and Apparatuses”, to Costales and Flynt, which are incorporated by reference herein in their entireties. Cross reference is made to U.S. Pat. application Ser. No. 10/002,716, filed Nov. 1, 2001, to Costales, U.S. Pat. No. 09/893,720, filed Jun. 28, 2001, to Costales, U.S. Pat. No. 09/721,046, filed Nov. 22, 2000, to Costales, U.S. Pat. No. 09/664,084, filed Sep. 18, 2000, to Costales et al., U.S. Pat. No. 09/565,662, filed May 5, 2000, to Costales, U.S. Pat. No. 09/565,657, filed May 5, 2000, U.S. Pat. No. 09/354,230, filed Jul. 16, 1999, to Costales, each of which is incorporated herein in their entireties.

### FIELD OF THE INVENTION

The present invention relates generally to a system and method for producing stereoscopic images and specifically to a system and method for producing stereoscopic images, preferably with a single lens, that can be used in microscopes, endoscopes, video devices, photographic devices, and the like.

### BACKGROUND

Stereoscopic imaging is useful in a broad variety of applications and devices, such as microscopes, endoscopes, video devices, photographic devices, to name but a few. Generally, stereoscopic images are produced by dividing light reflected by or transmitted through the object into two parts or images of the object, e.g., left and right eye views. The two parts or images, when viewed by a viewer, will produce a three-dimensional image of the object as each eye will see a different image of the object. The images can be viewed simultaneously as with two oculars, or sequentially, as with video, to provide the three-dimensional image.

There are a large number of stereoscopic imaging techniques. For example, U.S. Pat. No. 6275335 to Costales uses a light valve at the aperture stop or conjugate of a lens system that differently encodes light passing along the optical path. U.S. Pat. No. 4,189,210 to Browning and U.S. Pat. No. 3,712,199 to Songer disclose that an anaglyphic effect can be achieved by interposing complementary colored filters in an imaging lens system to form light portions having different wavelength distributions. U.S. Pat. No. 4,761,066 to Carter discloses that orthogonally disposed polarizing filters adjacent to a microscope's lens system will produce a stereoscopic image in that instrument by forming differently polarized light portions. Using the same approach as Carter, JP 08152561 to Toshihisa discloses the placement of opposing polarizing filters inside the objective lens of a microscope to produce a stereoscopic image in that instrument. U.S. Pat. No. 5,471,237 to Shipp and U.S. Pat. No. 5,828,487 to Greening, et al., use an active shutter-type mechanism to switch alternatively between light transmissive and opaque states to create a series of discrete images of the object.

A number exotic of aperture valves have been developed for stereoscopic applications. For example, U.S. Pat. No. 5671007 to Songer describes an aperture valve that employs two diagonal divisions to improve vertical resolution. In the absence of construction details, the aperture valve appears to have been constructed in the manner common at that time; that is, the valve would have been constructed with leading and trailing polarizing filters covering the entire aperture stop. U.S. Pat. No. 5914810 to Watts discloses that an aperture valve can be built with liquid crystal technology. The aperture valve is divided into multiple vertical stripes to achieve uneven side-to-side switching, and only discloses that hexagonal pixels can be used to control the size of an iris. In an article entitled “Pinholes produce sharp focus”, Lutz Kipp and colleagues from the Universities of Kiel and Hamburg teach that pinholes covering the entire aperture stop can sharpen the image produced.

Each of the various techniques and light valves discussed above can suffer from one or more of high optical losses; limited magnification powers; alignment problems; distortion and visual noise from contaminants, keystoning, ghosting, double-image distortions, vignetting, etc.; reduced stereoscopic information as magnification is increased; viewer discomfort due for example to visual misalignment; reliability, performance, and maintenance problems due to the use of active rather than passive devices; the use of costly components; a limited ability to acquire images of objects that impact polarization such as the sky, water, or reflecting surfaces; high optical losses due to the use of multiple holes to divide the light into discrete images; loss of certain wavelengths of light; and complexity of use.

### SUMMARY OF THE INVENTION

These and other needs are addressed by the devices and methods of the present invention. As set forth below, the various devices and methods produce stereoscopic and non-stereoscopic images with a lens system.

The present invention generally produces a 3D effect by encoding an imaging signal to isolate or otherwise acquire portions of the imaging signal that correspond to depth information (i.e., in the Z-direction) as well as length and width information (i.e., in the X- and Y-directions) regarding an object reflecting or transmitting the imaging signal. As used herein, “encoding” means causing a differentiation between signal portions passing (typically simultaneously) through a defined spatial area. This is typically performed using one or more encoders that occlude and/or retard and/or alter a characteristic of one image signal portion relative to another image signal portion. For example, in light-based imaging signals polarization is one method used as the basis for encoding the signal portions and thus producing the perceivable difference. In that event, the two signal portions have transversely oriented (typically orthogonal) polarization orientations.

The imaging signal can be in the form of radiant energy (with a wavelength range of from about 400 nm. to about 800 nm. being typical). The radiant energy can be in the form of light energy, and can additionally be thermal energy, sound energy, electromagnetic energy, x-ray energy, fluid energy, particle energy, and any energy with cyclic or wavelike properties that can be focused to produce an aperture stop or the equivalent of an aperture stop.

In a first embodiment, a system for producing, from a received imaging signal, a direct three-dimensional image of the object in a first mode and a two-dimensional (or inverse stereoscopic) image of the object in a second mode is provided. As will be to appreciated, two-dimensional images are rendered in only two dimensions, such as width and height (or X and Y), direct three dimensional images are rendered in three dimensions, such as width, height, and length (or X, Y, and Z), and inverse three dimensional images are rendered with length (Z) image information reversed (background ahead of foreground). The system comprises:

(i) at least a first encoder operable to encode the received imaging signal to produce at least an encoded first imaging signal;

(ii) at least a second encoder, positioned at or near an aperture stop and/or a conjugate thereof, operable to encode differently portions of the first imaging signal to produce at least second and third imaging signal portions; and

(iii) at least a third encoder operable to encode the second and third imaging signal portions. In a first mode, the first, second, and third encoders are configured to output second and third imaging signal portions having at least one differing optical characteristic, and, in a second mode, the first, second, and third encoders are configured to output second and third signal portions in which the differing optical characteristic is at least substantially the same.

As used herein, “aperture stop” or “aperture stop plane” of a lens system limits the size of the axial cone of energy which is accepted from object space and transferred to image space. It is the property of the aperture stop that all light emanating from a point in three-dimensional object space and accepted by a lens system generally fills the aperture stop; that is, the resultant image in image space within the imaging system is made up of an approximately even distribution of rays which have traveled equally throughout the entire area of the aperture stop. The entire optical path of a collimated beam of energy is a continuous aperture stop. In contrast, an uncollimated beam of energy typically has one or more discrete (spaced apart) aperture stops. Typically, the second encoder is positioned within a distance of the aperture stop of no more than about one aperture stop diameter; more typically within a distance of the aperture stop of no more than about 75% of the aperture stop diameter; and even more typically within a distance of the aperture stop of no more than about 50% of the aperture stop diameter. In one configuration, the second encoder is located in the lens of the optical or lens system, and the first and third encoders are located outside the lens system. As will be appreciated, a lens element is any optical element that refracts light in a generally uniform or defocused manner. A lens is typically composed of one or more lens elements, constructed or arranged such that the lens elements work together to achieve a generally more complex result than is commonly achieved by a single lens element.

The optical characteristic that is different between the imaging signal portions in the three dimensional mode is typically one or more of phase, polarization orientation, wavelength distribution, and intensity.

The first and third encoders can be any suitable active and/or passive encoding device, such as a plane or circular polarization filter, a polarization rotator, a rotating polarizer, a color (e.g., chromatic) or a non-color (e.g., an achromatic) filter, an occluder (a device that primarily reduces signal intensity), a retarder (or phase shifter), a reflector or mirror (such as a prism, beam splitter, birefringent element, etc.), and a shutter (a device that variably and/or controllably occludes all, some, or none of the image signal).

The second encoder can also be any suitable active and/or passive encoding device that provides two imaging signal portions having one or more different optical characteristics. For example, the second encoder can be one or more variable (active) polarization retarders (such as liquid crystals (including ferro-electric crystals)), rotating polarizers, Pi cells, fixed (passive) polarization retarders, and combinations thereof. In one configuration, the second encoder comprises a pair of active polarization retarders that are alternately energized over time. In other configurations, the second encoder is one or more of transversely oriented wave retarders, transversely oriented polarization retarders, and transversely oriented frequency retarders.

The optical system can be alternated between stereoscopic and non-stereoscopic (or two dimensional) modes by any suitable technique. In one configuration, in the stereoscopic mode the first, second, and third encoders are in the optical path and in the non-stereoscopic mode at least one of the first, second, and third encoders are not in the optical path. In another configuration, one or both of the first, second, and third encoders is rotated to change between the two modes. In the stereoscopic mode, the polarization orientations of the second and third signal portions are transverse, and, in the non-stereoscopic mode, the polarization orientations of the second and third signal portions are at least substantially parallel.

In one configuration, the second and third signal portions are directed to different oculars for viewing by a user. This is accomplished using a signal director (e.g., a beam splitter and/or birefringent crystal) operable to direct the second and third imaging signal portions along spatially distinct second and third optical paths, respectively.

In another embodiment, a method for producing, from an imaging signal, a three-dimensional image of an object in a first mode and a two-dimensional image of the object in a second mode. The method comprises the steps of:

(i) encoding the received imaging signal to form at least an encoded first imaging signal;

(ii) passing the first imaging signal through an encoder, positioned at or near an aperture stop and/or a conjugate thereof, to encode differently portions of the first imaging signal and form at least second and third imaging signal portions; and

(iii) encoding the second and third imaging signal portions. In a stereoscopic mode, the second and third imaging signal portions have at least one differing optical characteristic, and, in the non-stereoscopic mode, the differing optical characteristic of the second and third signal portions is the same.

In a typical configuration, the passing step comprises;

during a first time interval, energizing, de-energizing, and/or reversely energizing a first portion of the encoder and another of energizing, de-energizing, and/or reversely energizing a second, different portion of the encoder; and

during a second, later time interval, energizing, de-energizing, and/or reversely energizing the second portion of the at least one encoder and another of energizing, de-energizing, and/or reversely energizing the first portion of the encoder. Stated another way, the passing step comprises;

during the first time interval, passing at least most of the second imaging signal portion but not at least most of the third imaging signal portion; and

during the second, later time interval, passing at least most of the third imaging signal portion but not at least most of the second imaging signal portion. Typically, the second and third imaging signal portions are each formed from about 25% to about 50% of the first imaging signal and, during the first time interval, the second imaging signal portion is at least about 43.5% of the first encoded signal and the third imaging signal portion is no more than about 16.5% of the first encoded signal, and, during the second time interval, the third imaging signal portion is at least about 43.5% of the first encoded signal and the second imaging signal portion is no more than about 16.5% of the first encoded signal.

The above embodiments permit a user to select between a variety of operating modes, namely 2D, 3D, and/or inverse 3D. A single lens can be constructed such that it can be used for two or more of the 3D, inverse 3D, and 2D modes, as desired. Providing a single device to operate in two or more of these modes, is not only cost effective but also convenient for the user.

In yet another embodiment, a light valve or optical encoder is provided that comprises:

(i) a first region configured to transmit at least about 75% of at least a portion of the light contacting the first region or to occlude at least about 75% of at least a portion of the light contacting the first region; and

(ii) a second region, the second region comprising a plurality of first subregions spatially distributed in at least a second subregion. The first subregions are transmissive or opaque and the second subregion is the other of transmissive or opaque. The first subregion is typically continuously (and often uniformly) distributed over the light contacting surface of the light valve while the second subregion is typically discontinuously distributed over the light contacting surface, often in a uniform or substantially uniform pattern. Additionally, the first subregion is typically at least substantially uniformly transmissive or occlusive of light contacting the first region.

The relative areas of the first and second regions varies. Typically, the first and second regions each cover from about 25% to about 75% of a common light contacting surface of the light valve. The area of the first subregions typically ranges from about 10% to about 90% of the area of the second subregions.

In one configuration, one (or both) of the first and second subregions comprises a liquid crystal material bounded by dikes. The liquid crystal material and dikes are positioned between optically transmissive plates, and in contact with a pair of electrodes for applying voltage to the liquid crystal material.

In another configuration, one (or both) of the first and second subregions comprises a (passive) optical retarding material sandwiched between opposing optically transmissive plates.

In another configuration, one of the first and second subregions comprises an opaque and/or semi-opaque material with the other of the first and second subregions comprising a transparent or optically transmissive material.

The use of the first and second subregions over part of the light valve can provide a sharpening effect over that portion of the light valve, particularly when the light valve is positioned at the aperture stop and/or conjugate thereof, while maintaining optical losses at or below selected levels. As will be appreciated, the magnitude of the sharpening effect is pronounced when the size (length and width or diameter) of the discontinuous first or second subregions is less than about the wavelength of the light in the imaging signal.

In yet another embodiment, a method for encoding an optical signal is provided that comprises the steps of:

(i) providing at least first, second, third and fourth optical regions, wherein the first, second, third and fourth optical regions are in an at least substantially non-overlapping relationship, at least the first and second regions having variable optical transmissivity (e.g., comprising an active optical material such as a liquid crystal material), and the third and fourth optical regions having differing optical transmission characteristics (e.g., comprising an active or passive optical material);

(ii) in a first time interval, energizing the first region while de-energizing and/or reversely energizing the second region; and

(iii) in a second, later time interval, energizing the second region while de-energizing and/or reversely energizing the first region.

In one configuration, the third and fourth regions have variable optical transmissivity (e.g., each comprise an active optical material such as a liquid crystal) and in the first time interval the third and fourth regions are de-energized and/or reversely energized. In this configuration, the method further comprises the steps of:

in a third, later time interval, energizing the third region while at least one of de-energizing and reversely energizing the first, second and fourth regions; and

in a fourth, later time interval, energizing the fourth region while at least one of de-energizing and reversely energizing the first, second, and third regions. This configuration is particularly useful for stereoscopic applications. The first and second regions are alternately energized to provide for horizontal head motion parallax, and the third and fourth regions are alternately energized to provide for vertical head motion parallax.

In another configuration, the first and second regions each comprise a liquid crystal material, the third region comprises an optically transmissive material, and fourth region comprises an optically occlusive material.

The various light valve configurations of this embodiment can be inserted into the aperture stop or conjugate thereof of any imaging lens system to enable the lens system to produce stereoscopic video, still, or motion picture image sequences. The light valves can be readily retrofitted into any existing lens system and can be manufactured into any new lens system.

In yet another embodiment, an optical system is provided that comprises:

(i) at least a first encoder configured to encode from about 45% to about 80% of a received imaging signal to form a first encoded imaging signal and an unencoded imaging signal and

(ii) at least a second encoder configured to encode at least about 80% of the first encoded and unencoded imaging signals to form a second encoded imaging signal.

In one configuration, the first encoder comprises at least first and second encoder portions. The first encoder portion has a polarization orientation that is transverse to a polarization orientation of the second encoder portion.

In another configuration, the optical system comprises a third encoder configured to encode from about 45% to about 80% of the second encoded imaging signal to form a third encoded signal and a fourth unencoded imaging signal. The third encoder typically comprises at least first and second encoder portions, with the first encoder portion having a polarization orientation that is at least substantially parallel to a polarization orientation of the second encoder portion.

In one configuration, the first and third encoders have the same shape, are positioned on either side of the second encoder, and at least substantially overlap one another in the optical path. The second encoder is positioned at or near an aperture stop and/or conjugate thereof.

The light valve of this embodiment can provide enhanced 3D imaging. The reduced sizes of the first and third encoders can substantially decrease optical losses compared to larger sizes of encoders.

In yet another embodiment, an iris for an optical system is provided that comprises a plurality of pixels, each of the plurality of pixels having varying optical transmissivity and being independently controllable to provide a desired optical output. Each pixel typically comprises an active optical material, such as a liquid crystal material, and is operatively connected to a respective pair of electrical conductors. So configured, each of the plurality of pixels is independently controllable between optically occlusive and transmissive states.

In one configuration, the iris operates by energizing a first set of pixels place the pixels in the first set of pixels in one of an optically occlusive and optically transmissive state while de-energizing or reversely energizing a mutually exclusive second set of pixels to place the pixels in the second set of pixels in the other of one of an optically occlusive and optically transmissive state.

In another embodiment, the iris is formed by a transmissive microdisplay. The transmissive microdisplay permits the use of a high pixel density per unit area. The high pixel density provides a high degree of control over and fine tuning of the iris aperture size.

In yet another embodiment, the iris is used to filter out desired wavelengths of light in selected regions of the iris. For example, one set of pixels in the iris can pass a first but not a second wavelength of light while the pixels in a mutually exclusive second set of pixels passes the second wavelength of light (and/or not passes the first wavelength of light). By way of illustration, the pixels can be used to tint light passing through all or part of the pixels, grey out light passing through all or part of the pixels, and overlay textures on light passing through all or part of the pixels.

The various irses noted above can provide a number of advantages over conventional mechanical ires. For example, the digital irises can provide a much quicker response time and higher degree of iris aperture control compared to conventional mechanical irises. The fast switching and response time permits the characteristics of the aperture stop to be changed at a rate faster than the exposure. This iris can also switch alternate sides of the iris to generate a stereoscopic frame-sequential image capture. As will be appreciated, it is highly advantageous to combine left and right switching with iris control in the same apparatus. The iris can be used either as a shutter or an iris, as desired. This permits the iris to replace two otherwise distinct optical components, namely the mechanical iris and shutter.

The various optical components described above can have a number of advantages. By way of example, the optical components can reduce the otherwise high optical losses of conventional light valves, provide high magnification powers, provide ease of alignment; suffer from low levels of distortion and visual noise from contaminants, keystoning, ghosting, double-image distortions, vignetting, etc., maintain levels of stereoscopic information as magnification is increased; avoid viewer discomfort due for example to visual misalignment, provide high levels of reliability and performance with low levels of maintenance, avoid the use of costly components, readily acquire images of objects that impact polarization such as the sky, water, or reflecting surfaces, avoid losses of certain wavelengths of light, and provide ease of use.

### BRIEF DESCRIPTION OF THE DRAWINGS

FIG. 1 shows an exploded view of the components that make up a transparent stereoscopic aperture-valve.

FIG. 2 shows the components that make up a stereoscopic video lens.

FIG. 3 shows diagrammatically a relay lens creating a conjugate of the original aperture stop.

FIGS. 4A, 4B, and 4C show alternative positions for the entrance polarizer.

FIGS. 5A and 5B show alternative positions for the exit polarizer.

FIGS. 6A, 6B, 6C, 6D, 6E, and 6F show that the gap or joint does not need to be straight.

FIG. 7 shows perforations, holes, or occlusions on the filter's surface.

FIG. 8 shows that the filter's surface may be laid down in strips or other patterns.

FIG. 9 shows that the transparent light valve can be divided into multiple quadrants.

FIG. 10 shows diagrammatically a 3D video adapter.

FIG. 11 shows in exploded view a 3D video adapter.

FIG. 12 shows that the transparent light valve can be used with a binocular viewing device.

FIG. 13 shows that the transparent light valve can be used with frame parallel image capture.

FIG. 14 shows that a half filter can be perforated.

FIG. 15 shows that a half filter can be half covered with occlusions.

FIG. 16 shows the quadrants of an aperture valve.

FIG. 17 shows the components of a PRIOR ART aperture valve.

FIG. 18 shows components of an improved aperture valve.

FIG. 19 shows the quadrants of an improved aperture valve.

FIG. 20 shows that the clear areas may join.

FIG. 21 shows that the improved aperture valve can be constructed from off-the-shelf liquid crystal switches.

FIG. 22 shows that the improved aperture-valve can be used with a beam-splitter.

FIG. 23 shows a digital iris installed in a lens.

FIG. 24 shows three properties of a digital iris.

FIG. 25 shows a round iris stereoscopic digital iris.

FIGS. 26A, 26B, and 26C show variation in the round iris diameter.

FIGS. 27A and 27B show frame sequential half-round openings with variations in the diameter of the round iris.

FIGS. 28A and 28B show frame sequential three-quarter-round openings with variations in the diameter of the round iris.

FIGS. 29A and 29B show frame sequential one-quarter-round openings with variations in the diameter of the round iris.

FIG. 30 shows a rectangular stereoscopic digital iris.

FIGS. 31A, 31B, and 31C show variation in the rectangular iris diameter.

FIGS. 32A and 32B show frame sequential half-rectangular openings with variations in the diameter of the rectangular iris.

FIGS. 33A and 33B show frame sequential three-quarter-rectangular openings with variations in the area of the rectangular iris.

FIGS. 34A and 34B show frame sequential one-quarter-rectangular openings with variations in the area of the rectangular iris.

FIG. 35 shows a high resolution digital iris.

FIG. 36 shows that the opening does not need to be a rectangle.

FIG. 37 shows that complex dot patterns can be produced in stereoscopic mode.

FIG. 38 shows that images can be produced by the digital iris.

FIGS. 39-40 depict applied voltage levels as a function of time for optical components 103 and 105, respectively.

FIGS. 41-42 depict levels of light transmitted as a function of time for optical components 103 and 105, respectively.

FIG. 43 shows one way to construct a spot with a liquid crystal retarder.

FIG. 44 shows one way to construct a spot with a passive retarder.

FIGS. 45-48 depict applied voltage levels as a function of time for the optical components 914, 105, 915, and 103 respectively.

FIG. 49 shows each pixel in one version of the digital iris.

FIG. 50 shows each pixel in a rectangular variation on the digital iris.

FIG. 51 shows how a rectangular array of pixels can approximate a true circle.

### DETAILED DESCRIPTION OF THE INVENTION

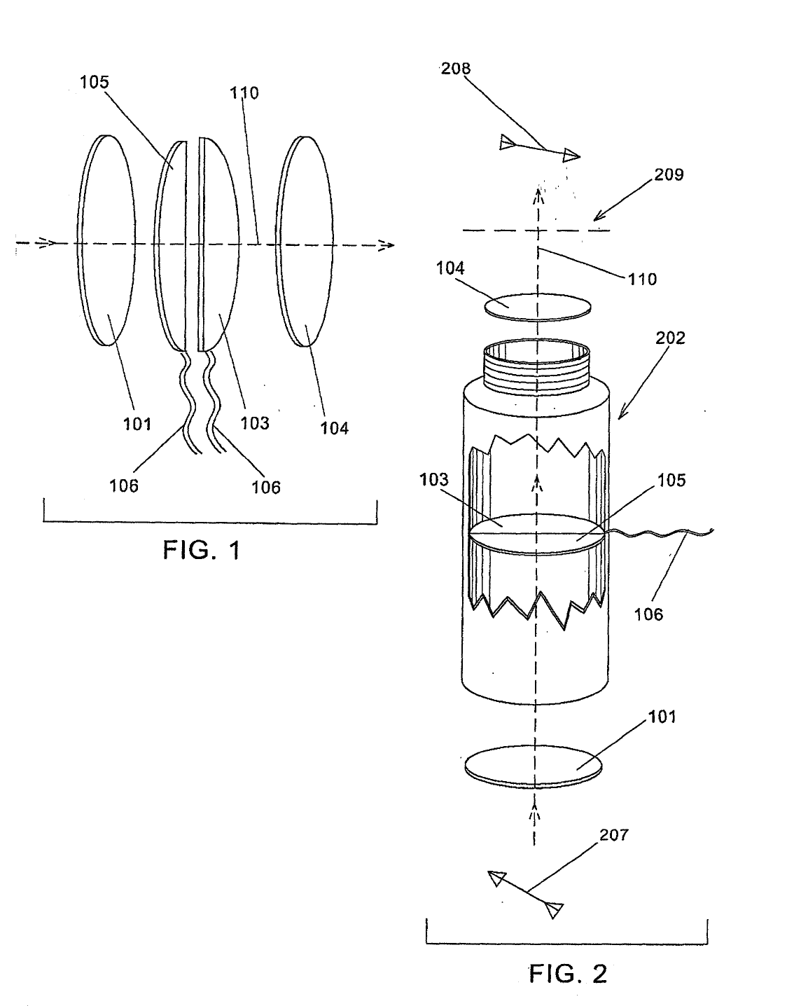

FIGS. 1-13 disclose a transparent stereoscopic aperture-valve. Shown diagrammatically in FIG. 1 is a transparent stereoscopic aperture-valve capable of insertion into the aperture stop, any conjugate of the aperture stop, of any imaging lens system to enable that lens system to produce stereoscopic video, still, or motion picture image sequences. This transparent stereoscopic aperture-valve can be retrofitted into any existing lens system and can be manufactured into any new lens system. Examples of such lens systems include microscopes, endoscopes, video lenses, still camera lenses, ocular fundus lenses, inspection lenses, video lens adapters, still camera lens adapters, binocular adapters, monocular adapters, and motion picture lenses. Although these examples are the only ones cited, they are not intended to be limiting. Any imaging lens system can be used to exploit this transparent stereoscopic aperture-valve and such unforeseen applications are considered a part of this embodiment.

The transparent stereoscopic aperture-valve is capable of producing a sequence of images that can later be viewed in 3D, also called stereovision or human stereopsis. FIG. 1 illustrates diagrammatically one form of such a transparent stereoscopic aperture-valve.

FIG. 1 shows the components that form the transparent stereoscopic aperture-valve. The transparent stereoscopic aperture-valve is made of at least four components. An entrance polarizing filter 101 is first in the light path (as indicated by the dashed line 110) and is typically not placed at or near an aperture stop. An exit polarizing filter 104 is last in the light path and is also typically not placed at or near an aperture stop. Between the two is at least a pair of transparent components 103 and 105 placed at or near the aperture stop of a lens system, or at or near a conjugate of the aperture stop of a lens system. As used herein, “at or near” refers to a position preferably within about the distance of the diameter of the aperture stop and more preferably within about one tenth the distance of the diameter of the aperture stop or conjugate thereof.

The transparent stereoscopic aperture-valve components 103 and 105 are both placed at or near the aperture stop, or at or near a conjugate of the aperture stop, or the first of the pair of transparent stereoscopic aperture-valve components (103 or 105) is placed at or near one aperture stop or a conjugate of the aperture stop, and the second of the pair of transparent stereoscopic aperture-valve components (the other of 103 or 105) is placed at or near a different aperture stop or different conjugate of an aperture stop. In either configuration, the components 103 and 105 are positioned in an at least substantially non-overlapping relationship such that they each encode at least about 50% and more preferably from about 25% to about 50% of discrete portions of the light.

The transparent stereoscopic aperture-valve components 103 and 105 can be constructed from any of a variety of standard optical components, among which are: fixed polarization retarders (as for example quarter-wave retarders orthogonally oriented or half-wave retarders orthogonally oriented); or variable polarization retarders (as for example orthogonally energized liquid crystals, or orthogonally energized fero-electric crystals). That we speak of transparent is not to be taken as limiting. It is well known that liquid crystals reduce light transmission by about 2%. Clearly that we speak of transparent can be reasonably construed to include transmission reductions that range from truly transparent (0% light loss) to near transparent (25% light loss) and will still be considered a part of this embodiment.

FIG. 1 is an exploded diagrammatic view of the stereoscopic aperture-valve. It shows that the each of the pair of transparent stereoscopic aperture-valve components 103 and 105 covers approximately one-half the area of the aperture stop with the joint, or gap between the two halves oriented vertically or near vertically. The vertical orientation is relative to normal upright orientation of the lens system into which the components are installed, or when the lens system is not horizontal the vertical orientation is relative to the normal upright orientation of the intended imaged subject.

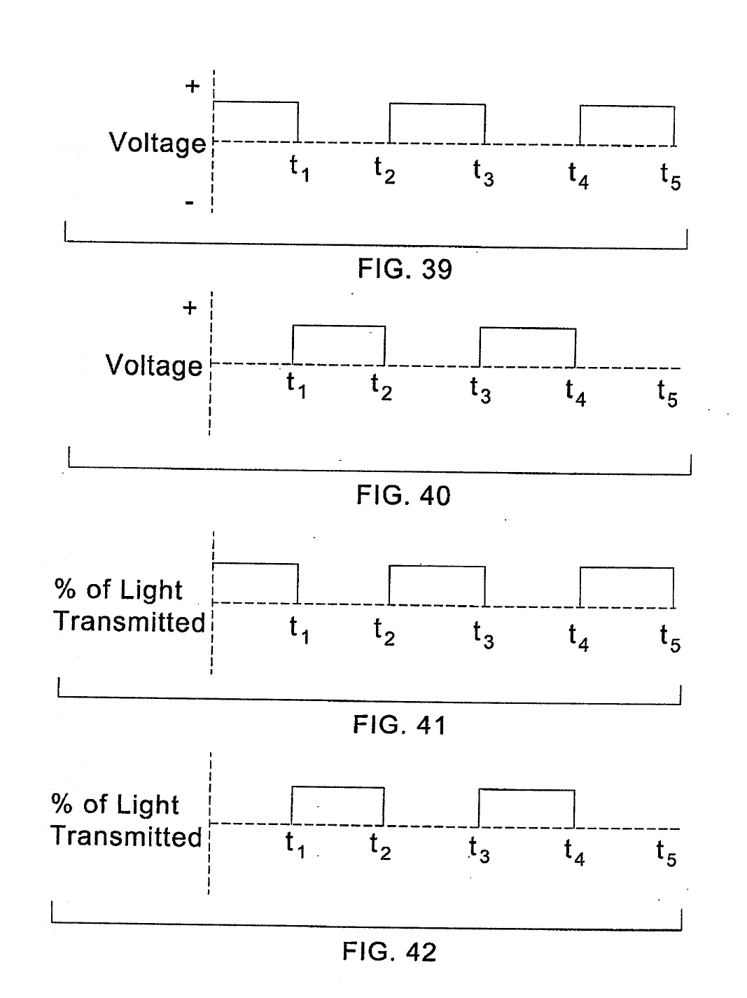

The transparent stereoscopic aperture-valve components, 103 and 105, when constructed with variable retarders, are alternately energized (as in FIGS. 39 and 40) by signals carried over wires 106. For example and as illustrated in FIGS. 39, 40, 41 and 42, during a first time interval t₂t₃, one side (FIGS. 39 and 41) is energized to retard polarized light by about a half-wave on that (first) side, while the other side (FIGS. 40 and 42) remains non-energized or reversely energized, non-retarded or reversely retarded. Then during a later, discrete, second time interval t₂-t₃, the first side is de-energized or reversely energized, and the second side is energized or reversely energized to retard polarized light by about a half-wave on that (second) side. Stated another way, the first and second sides are energized/de-energized or reversely energized in opposing or alternate cycles to output light in each side that is differently polarized or otherwise encoded.

The exit polarizing filter 104 has its polarization orientation oriented approximately in parallel to the polarization orientation of the entrance polarizing filter 101, or approximately orthogonally opposite to it, or approximately 45 degrees to it. The orientation determines the de-powered state of the entire system. For example, if the exit filter 104 is orthogonally opposite to the entrance polarizing filter 101, the polarized light output by either the first or second sides having the same polarization as the exit filter 104 will be passed by the filter while the differently polarized light on the other side will be at least substantially blocked. The preferred orientation is for the polarizing filters 101 and 104 to be parallel, wherein the de-powered states of components 103 and 105 will allow both sides of the aperture stop to transmit image information. This orientation is most desirable for medical video applications and is less desirable for photographic film applications.

Shown in FIG. 2 is a claimed apparatus that is illustrative of the transparent stereoscopic aperture-valve. FIG. 2 shows a typical lens system 202 capable of imaging a subject 207, image signal encoding the subject's depth information with an entrance polarizing filter 101 not at the aperture stop of the system, a pair of transparent stereoscopic aperture-valve components 103 and 105 at the aperture stop of the lens system, and an exit polarizing filter 104 not at the aperture stop of the lens system, and recording that image on the image plane 208. The image plane 208 is the image plane of a typical camera, the body of which is represented by dashed line 209, and is the front surface of an Image Orthicon tube, a CCD array, CMOS array, positive film, negative film, or any other image recording surface. The camera is analog or digital. The direction of light through the lens system is indicated by dashed line 110.

The lens system is capable of producing a sequence of images that can later be viewed in 3D, also called frame sequential stereovision or human stereopsis. FIG. 2 illustrates such a lens system. Any one of many common forms of lenses are generically represented by the cylinder pictured at 202. Although FIG. 2 shows a fixed focal length lens, this assumption is not intended to be limiting, however, because it is well known that lenses can be constructed to vary their focal length, where such lenses are commonly referred to as “zoom” lenses. Such variable focal length lenses may nevertheless be employed in the invention and those skilled in the optic arts will readily be able to extend the present principles to variable focal length lenses.

A pair of transparent stereoscopic aperture-valve components 103 and 105 are placed at or near the aperture stop of the lens system 202. This assumption is not intended to be limiting, however, as it is well known that lens systems may have multiple effective aperture stops, called the aperture stop and its conjugates. Such alternate locations of the aperture stop may nevertheless be employed in the invention and those skilled in the optic arts will readily be able to extend the present principle to any conjugate of the aperture stop. The assumption that the aperture stop is interior to the lens system is also not intended to be limiting, however, because it is well known that new conjugates of the aperture stop can be constructed in the light path prior to and/or in the light path subsequent to an existing lens system.

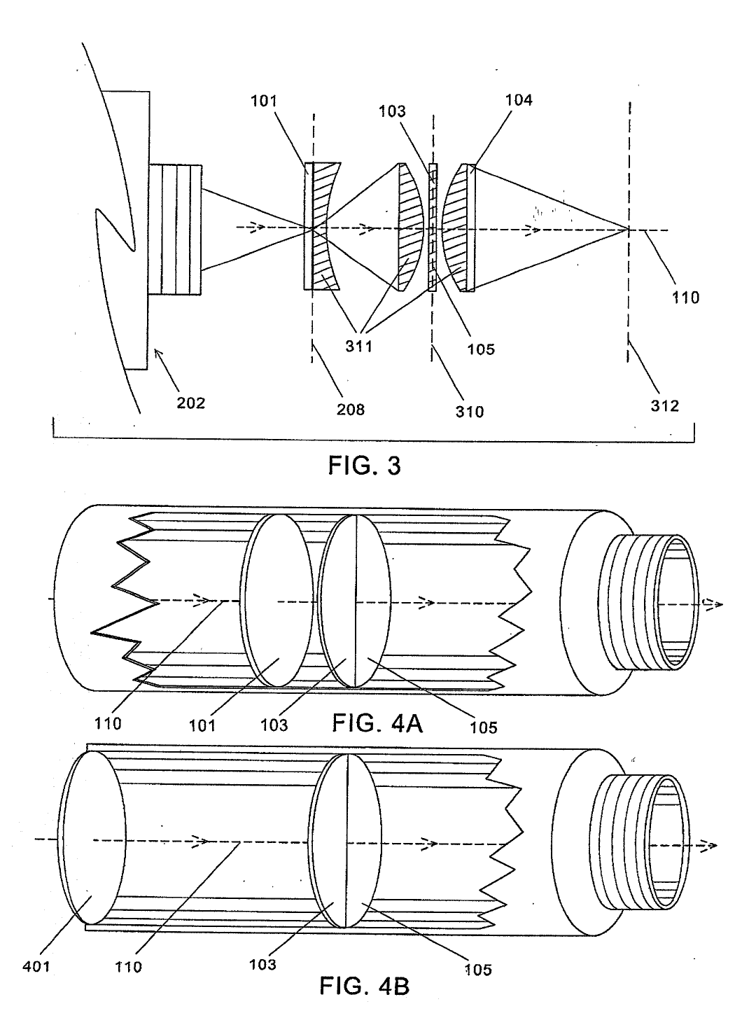

FIG. 3 shows the preferred embodiment which is one example of a new conjugate of an aperture stop created in the light path subsequent to an existing lens system 202. A typical relay lens system, shown bracketed by 311, gathers the image at the original image plane represented by the dashed line 208, and focuses a new image on a new image plane represented by the dashed line 312. Dashed line 110 shows the direction of light through the system. Between the old and new image planes a new aperture stop—the position of which is indicated by the dashed line 310 (a conjugate of the original aperture stop)—is created and the pair of transparent components 103 and 105 are placed at or near that plane. An entrance polarizing filter 101 is placed at the lens-end of the relay-lens system. An exit polarizing filter 104 is placed at the camera-end of the relay-lens system. New conjugates of aperture stops, whether in the light path prior to, or in the light path subsequent to the lens system, may nevertheless be employed in the invention and those skilled in the optic arts will be readily able to extend the present principle to placement of the pair of transparent components in any such created external conjugate of the aperture stop.

FIG. 2 shows that the joint or gap between or overlap of the pair of transparent components 103 and 105 approximately bisects one-half the area of the aperture stop with the bisecting joint or gap or overlap preferably oriented vertically or near vertically. In a preferred configuration each of the components 103 and 105 encode (or contact) from about 25% to about 50% of the light passing along the optical path shown in FIG. 2 by the dashed line 110. The vertical orientation is relative to normal upright orientation of the camera body, represented by the dashed line 209, to which the lens system 202 is attached. This orientation is not intended to be limiting, however, as it is well known that some lens systems rotate during use. For lens systems that rotate, the pair of transparent components 103 and 105 either attaches to a non-rotating component at the aperture stop, or is installed with hardware able to maintain the vertical orientation of its gap, joint, or overlap, while the lens system rotates, or is placed in an external aperture stop that does not rotate with the lens system. Such positioning or hardware modifications may nevertheless be employed in the invention and those skilled in the optic arts will readily be able to extend the present principles to any position or modification required to maintain a vertical orientation of the gap, joint, or overlap of the pair of transparent components in a rotating lens system.

As shown in FIG. 2, at least one entrance polarizing filter 101 is interposed anywhere in the light path between the light source (not shown) and the pair of transparent components 103 and 105, where the light source may be reflected light off the subject 207, or may be light transmitted through the subject 207, or subject 207 may emit its own light. The preferred position for a lens that is not dedicated to a single use is external to the lens system and optionally attached to the front of the lens system, as for example with a screw-on, clamp-on, or clip-on filter. Other positions are anywhere inside the lens system, except at or near the aperture stop, as shown in FIG. 4A at 101, or as a coating on any of the entrance lens elements of the lens system as shown in FIG. 4B at 401, or in front of a light source 418 illuminating the subject 207 as shown in FIG. 4C at 402, that is, anywhere in the light path prior to the pair of transparent components 103 and 105 in all three figures. In all three figures, the dashed line 110 shows the direction of light passing through the system.

That in FIG. 4C we show the light source 418 and filter 402 illuminating the front of the subject 207 is not to be taken as limiting. Clearly light source 418 and filter 402 may illuminate from behind the subject 207, or the subject 207 may emit its own polarized light, or any combination of these lighting sources, and any and all will still be considered a part of this embodiment.

The external position 101 of FIG. 2 is preferred for lenses that are not dedicated to a single use because it requires minimal modification of the lens. That position is not intended to be limiting, however, as it is well known that polarizing filters can be applied as coatings to lenses and can be positioned almost anywhere inside or outside a lens system. Any position for the entrance polarizing filter may be employed in the invention so long as that position is anywhere in the light path ahead of the pair of transparent components 103 and 105, and those skilled in the optic arts will readily be able to extend this principle to any acceptable position inside or outside of the lens system.

When the entrance polarizing filter 101 is in the light path prior to the lens system it is manually adjustable for alignment. When the polarizing filter is internal to the lens system as with 101 in FIG. 4A, or is applied to a lens as 401 in FIG. 4B, adjustment is made by altering (typically by rotation independent of the housing) the position of the transparent components. The means of orientation is not intended to be limiting, however, as it is well known that a polarizing filter can be oriented using any of a number of well known means. Any such means may nevertheless be employed in the invention and those skilled in the optic arts will readily be able to extend this principle to any means of orientation.

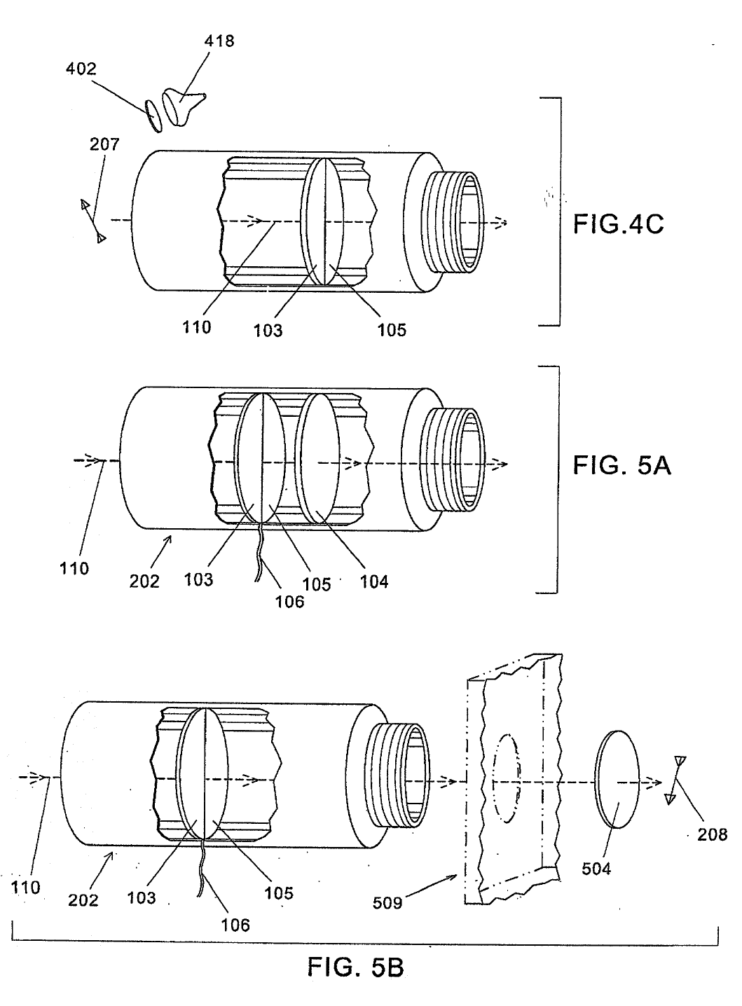

In FIG. 2, at least one exit polarizing filter 104 is placed anywhere in the light path between the pair of transparent components 103 and 105 and the image plane 208. The preferred implementation is outside the lens system, because this placement allows the lens system to be used for other purposes when not being dedicated to stereoscopic use. Other locations for the exit polarizing filter are shown in FIGS. 5A and 5B. The exit polarizing filter, when inside the lens system 202, must be in the light path subsequent to the pair of transparent components 103 and 105, but not at or near the aperture stop, as at 104 in FIG. 5A; when the exit polarizing filter is inside a camera body 509, it must be in the light path prior to the image plane 208, as at 504 in FIG. 5B. In both figures, the dashed line 110 shows the direction of light passing through the system.

As in FIG. 2, the exit polarizing filter 104 has its polarization orientation oriented appropriately for the polarization orientation of the entrance polarizing filter 101, or approximately orthogonally opposite to that orientation or approximately 45 degrees to that orientation. When the exit polarizing filter is outside the lens system as at 104, it may be adjustable (e.g., rotatable independently of the housing) to achieve proper orientation. When the exit polarizing filter is inside the lens system, as in FIG. 5A at 104, or inside the camera body, as in FIG. 5B at 504, the exit polarizing filter may be internally adjustable (e.g., rotatable independently of the housing), or may be manufactured to be in the correct alignment.

That we fail to describe reflecting surfaces is not intended to be limiting. It is well known that quality optical components are often coated with anti-reflective materials. Clearly, any such anti-reflective coating may be used to reduce the reflective properties of the signal encoding filter, and any such anti-reflective coatings may be used with, and will become a part of this invention.

That we fail to describe other filters is not intended to be limiting. It is well known that UV coatings are applied to optical components to protect such components such as liquid crystals from harm. It is also well known that IR coatings are applied to optical components to protect surfaces such as CCD image collectors from harm. Clearly, any coating or filters may be used with, and will become a part of this invention.

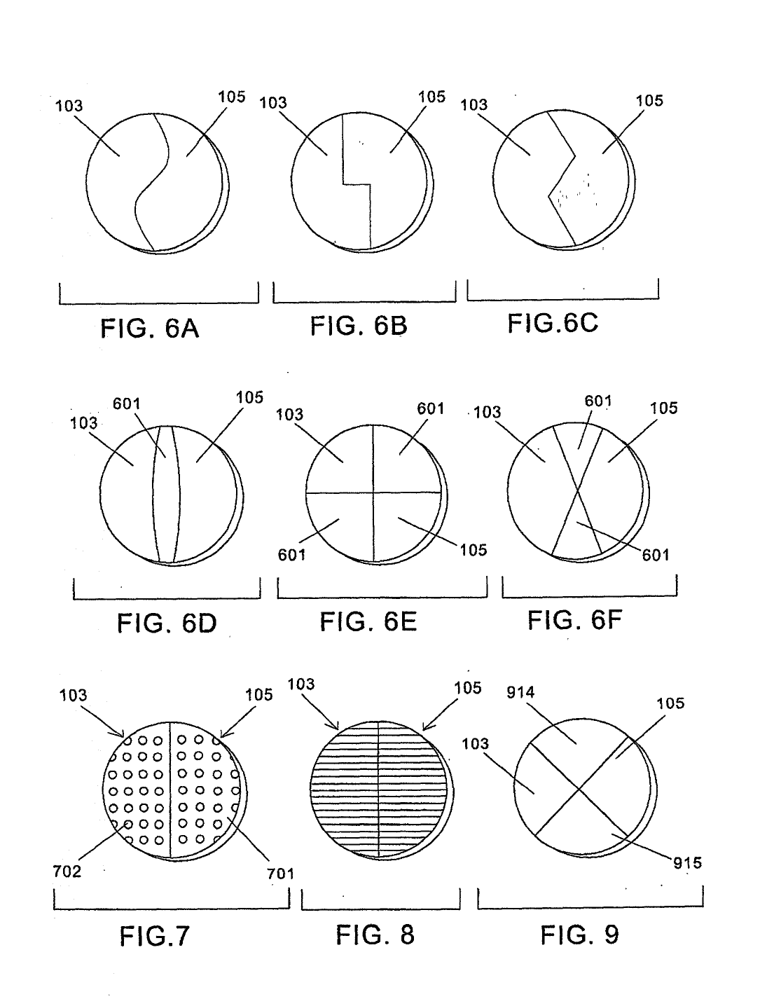

That we say that the gap or joint or overlap of the pair of transparent components approximately bisects the aperture stop with a straight division is not intended to be limiting. A straight bisection is not necessary for the 3D effect to work. FIGS. 6A, 6B, 6C, 6D, 6E, and 6F each show a gap or fully or near fully transparent, as at 601 (i.e., passing at least about 75% of light) in a predetermined wavelength band or fully or near fully occluded region (i.e., passing no more than about 25% of light in a predetermined wavelength band) between, or a joint, or an overlap of the pair of transparent components 103 and 105 which occupies approximately one half of the aperture stop, but which does not linearly bisect the aperture stop. Clearly most any shape will work including those that are asymmetric, and those skilled in the optic arts will be readily able to extend this principle to most any shape while not deviating from the intention of this invention.

The shape depicted at FIG. 6E has particular advantage when encoding a 3D image of a horizontal object, but does so at the expense of degrading the 3D information about some diagonal objects. As can be seen from FIG. 6E, regions 601 are transparent or near transparent areas in opposing quadrants while alternate occluding components 103 and 105 are also in opposing quadrants.

That we specify a single shape at any given time is not intended to be limiting. Because some shapes may be more suitable than others for the rendering of 3D for different objects, different shapes may be used over time or simultaneously to best render a scene or components of a scene. Although less desirable in the physical world, such custom tuning to individual scene objects is highly desirable in software implementations.

That we do not specify an achromatic transparent filter is not intended to be limiting. Achromatic transparent filters are necessary in applications where the true rendering of visual colors is desirable, but are not necessary where such renderings are not necessary, as in black and white imaging. Clearly those skilled in the optic arts will be readily able to select the most desirable quality of transparent filters based on specific application requirements, and any such selection shall be considered a part of this invention.

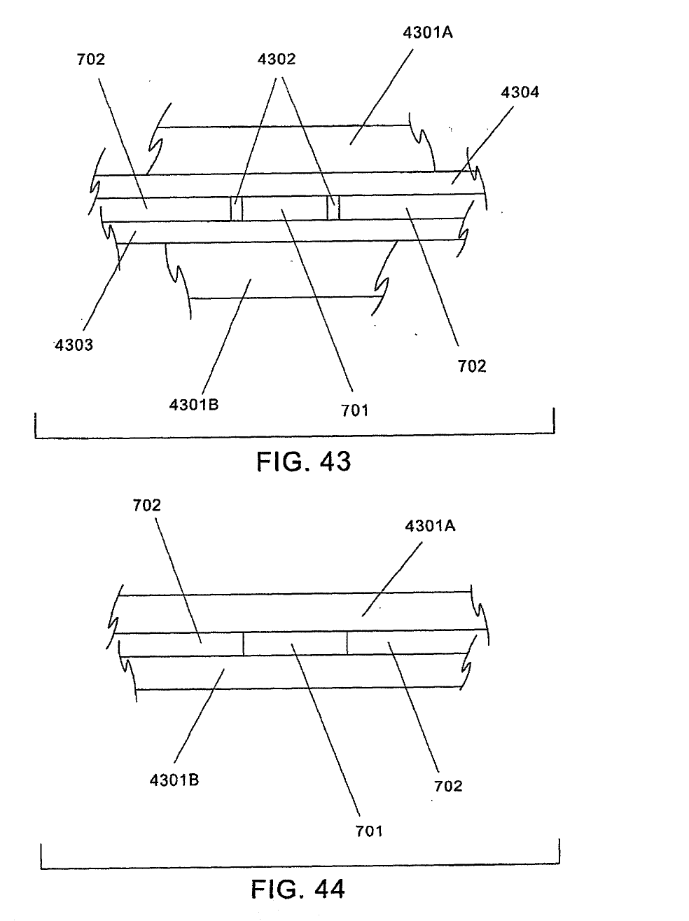

That we specify that the image is occluded (i.e., such that no more than about 15% of the light in a predetermined wavelength range is passed) sequentially on one half of the aperture stop and then on the other half of the aperture stop is not intended to be limiting. Full occlusion is neither necessary nor desirable. Full occlusion reduces the light transmission of the lens system by 99% or more. In actual practice it is only necessary to significantly reduce the image light passing through half the aperture stop. A reductive difference between the occluding and transmitting halves of the aperture stop of only three f-stops, or an 87.5% difference in light transmission, has been found to be sufficient to produce acceptable 3D. Greater occlusion is necessary when low contrast images are viewed or recorded. Preferably, the difference in light transmission between components 103 and 105 in their opposing energization cycles is at least about 87.5% and more preferably ranges from about 50% to about 100%. FIG. 7 shows one way to reduce the occlusion effect of the transparent components. Sides 103 and 105 are both perforated with areas 701 and 702 either being clear of occlusion or having occluding material applied in spots or areas to provide occlusion. FIG. 43 shows one way to achieve such an effect with liquid crystals. The liquid crystals are sandwiched between two glass plates 4301A and 4301B. Above the liquid crystals is a transparent conductor 4304, and below the liquid crystals is a transparent electrical common ground conductor 4303. The liquid crystals are held in place by dikes bracketed by 4302 that are applied lithographically or by other means. The active liquid crystals are either in the spot 701, or are in the area 702 between spots, or both with only one or the other being electrically activated. FIG. 44 shows one way to achieve the same effect with passive retarding material. The passive retarding material is sandwiched between two glass, quartz, or plastic plates 4301A and 4301B. The passive retarder material is either the spot 701 or the area 702 between the spots.

FIG. 8 shows the same effect as does FIG. 7, but with the transparent components 103 and 105 laid down in stripes or laid down solidly with stipes removed, using the same means as described above for spots.

That we show patterns to reduce the occluding effect is not intended to be limiting, however, because transparent filters may be applied to a substrate in a sparse or uneven manner that reduces its efficiency. Liquid crystals, for example, are “brushed” to align the crystals for maximum retardation. If, during the manufacturing phase, such crystals are less than completely brushed, the result will be that some light will be non-retarded and some light will be retarded while passing through the same media. Such a loss of efficiency will reduce the occluding effect.

The variable retarding transparent filter may also be powered with a reduced voltage, which will also have the effect of reducing its polarization retardation and thus reducing its occluding effect.

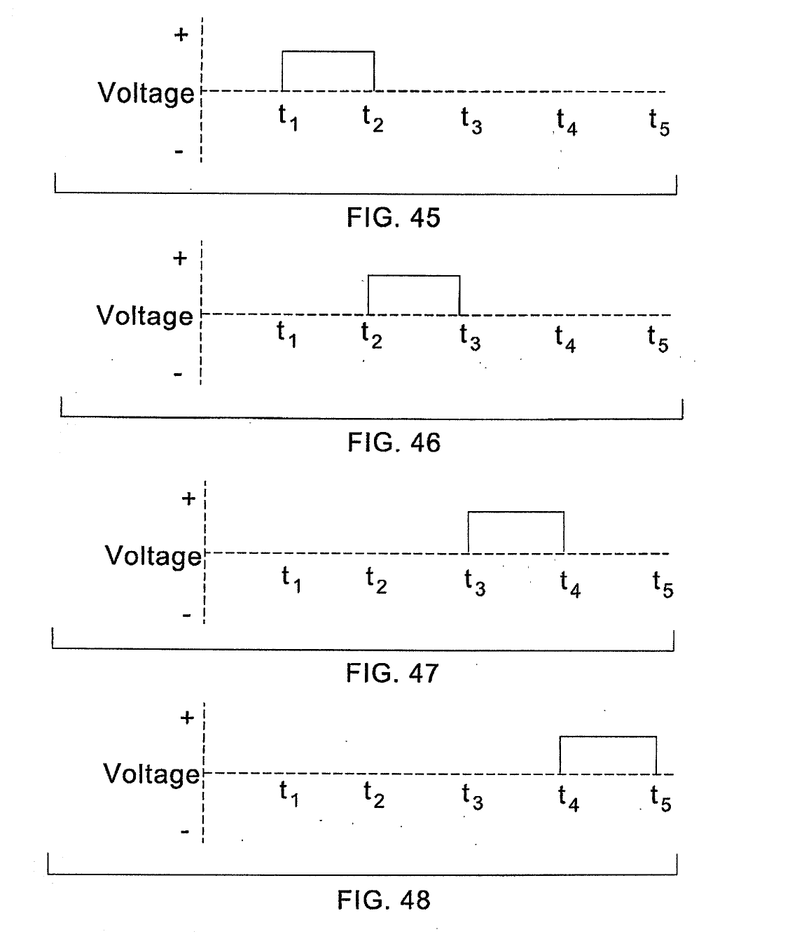

That we speak of dividing the aperture stop into two halves is not intended to be limiting because more than two divisions can also prove of value. FIG. 9 shows the aperture stop divided into four quadrants. Alternately occluded sides 103 and 105 provide 3D for horizontal head motion parallax. The top 914 and bottom 915 alternately occluded areas provide 3D for vertical head motion parallax. FIGS. 45, 46, 47, and 48 illustrate one time sequence that could be used with this configuration. In FIG. 45, section 914 of FIG. 9 is open during time interval t₁-t₂, while sections 103, 105, and 915 remain occluded. In FIG. 46, section 105 of FIG. 9 is open during time interval t₂₋ₜ₃, while sections 914, 915, and 103 remain occluded. In FIG. 47, section 915 is open during time interval t₃₋ₜ₄, while sections 914, 103, and 105 remain occluded. In FIG. 48, section 103 is open during time interval t₄-t₅, while sections 914, 915, and 105 remain occluded.

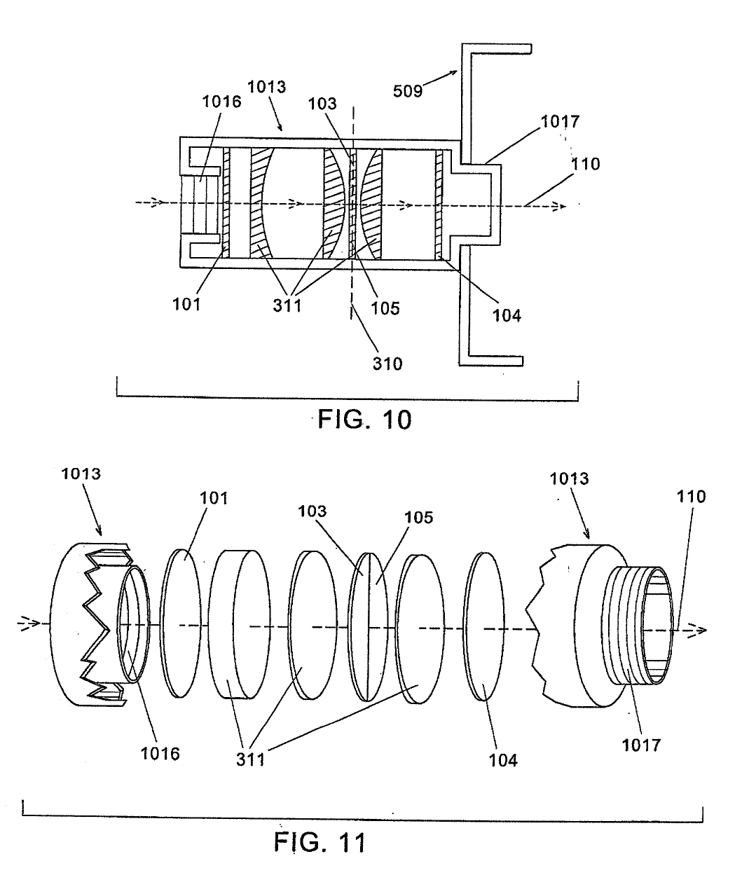

Shown diagrammatically in FIG. 10 is a preferred claimed apparatus that is illustrative of the transparent stereoscopic aperture-valve. An off-the-shelf or constructed relay lens system 311 has the transparent components 103 and 105 inserted at its internal aperture stop 310. Wires (not shown) control the alternate powering of the transparent components. A entrance polarizing filter 101 is installed at the leading end of the housing 1013 that contains the relay lens system 311. An exit polarizing filter 104 is placed at the trailing end of the housing 1013 that contains the relay lens system 311. A female C-mount 1016 is attached at the leading end of the relay lens system's housing 1013 so that a C-mount lens or a C-mount lens system may be mounted at that end. A male C-mount 1017 is attached at the trailing end of the relay lens system's housing 1013 so that a C-mount camera 509 can be mounted at that end.

FIG. 11 shows the same apparatus as in FIG. 10 in an exploded view.

That we illustrate a relay lens using only three optical elements is not intended to be limiting, however, because it is well known that relay lens systems can be constructed with a wide range of number of lenses. Such more or less complex relay lens systems may nevertheless be employed in the invention and those skilled in the optic arts will readily be able to extend the present principles to all such relay lens systems.

That we specify C-mounts is not intended to be limiting because lenses and cameras employ a wide range of standard and proprietary styles of mounts. Any style or form of mount may be mounted at either end of the relay lens system and such style of forms of mounts shall still be considered a part of this patent.

That we show the lens mount 1016 and the camera mount 1017 as fixed is not intended to be limiting. Movement between the relay lens system and the mounts allow the system to focus and adjust image size and orientation. Such movements may be locked as with set screws, or may be dynamic as with threads or other adjustment means and any such adjustment means will still be a part of this invention.

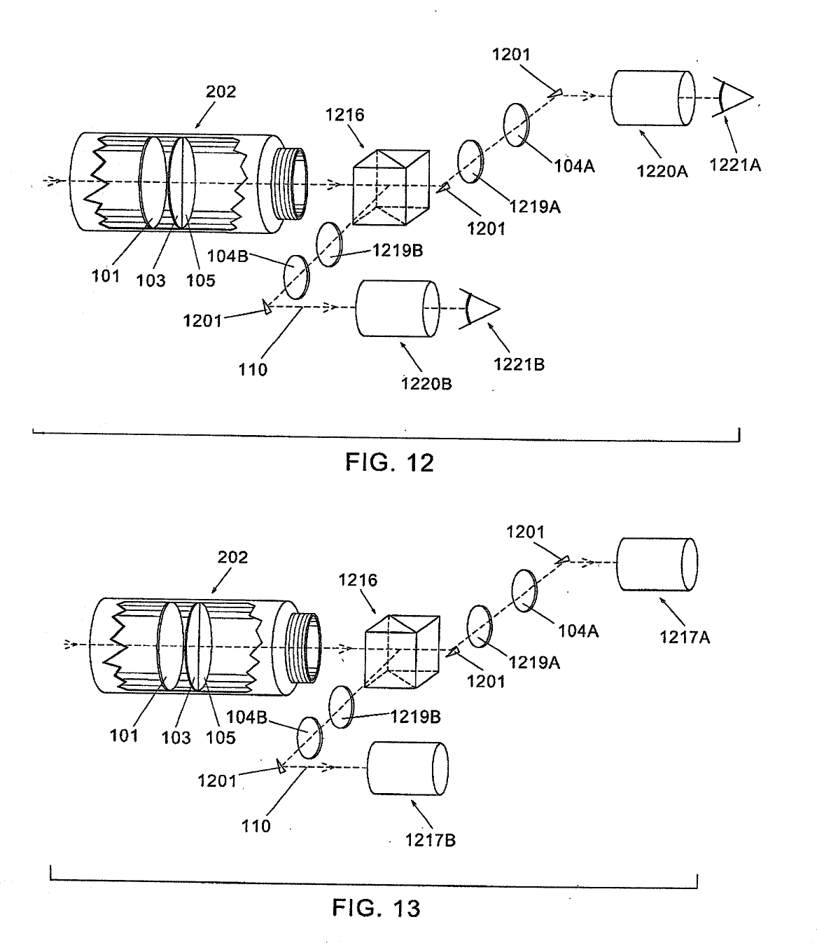

FIG. 12 shows a lens system 202 or a relay lens system as described earlier, that contains an entrance polarizer 101 prior to a pair of transparent components 103 and 105, where the pair of transparent components is located at or near the aperture stop of the lens system. Subsequent to the lens system in the light path is a beam splitter or birefringent crystal 1216. A first portion (e.g., half) of the light from the light path (as indicated by dashed line 110) is reflected by the beam splitter to a first side, and a second portion (e.g., half) of the light is allowed to pass straight through the beam splitter to the second side. Both of the two new light paths contain identical image information. In the case of passive transparent components, each new light path passes first through a retarder 1219A or 1219B. The polarization orientation of these two retarders 1219A and 1219B are set to be approximately orthogonal to each other. In the case of electrically switched transparent components, the components 1219A and 1219B are omitted. Those retarders 1219A and 1219B, if present, or the beam splitter 1216 if the retarders are absent, are followed in the new light paths by exit polarizing filters 104A and 104B. The polarization orientation of these two exit polarizing filters 104A and 104B are approximately parallel to each other, are approximately orthogonal to each other, or are approximately 45 degrees to each other. The orientation of 104A is arranged such that it blocks the light passing through leading polarizer 101 and one of the transparent components 103 or 105, and the orientation of 104B is arranged such that it blocks the light passing through leading polarizer 101 and the other one of the transparent components 103 or 105. The resulting images are then focused by appropriate oculars 1220A and 1220B so that the resulting image can be viewed directly by the human eyes 1221A and 1221B. The mirrors or prisms 1201 are arranged so that the images projected to the human eyes are roughly parallel and spaced appropriately for human viewing. The retarders 1219A and 1219B (if present) may appear on either side of the mirrors or prisms 1201, or between them, but must precede the exit polarizing filters 104A and 104B respectively. The exit polarizing filters 104A and 104B may appear on either side of the mirrors or prisms 1201, or between them.

FIG. 13 shows a system that is substantially the same as that shown in FIG. 12. In FIG. 13, the oculars (1220A and 1220B of FIG. 12) and human eyes (1221A and 1221B of FIG. 12) are replaced with cameras 1217A and 1217B.

That we show a prismatic depiction of a beam-splitter 1216 is not intended to be limiting because images for binocular viewing or recording can be split from one image stream using any of many common mechanisms including half-silvered mirrors, prisms, barrel prisms, and birefringents. No matter the mechanism employed, this invention shall be usable with any of them.

That we show simple oculars 1220A and 1220B is not intended to be limiting. Oculars can be manufactured in a range of magnifying powers, fields of view, and qualities and any such oculars shall be usable with this invention.

That we illustrate, in FIGS. 12 and 13, transparent components 103 and 105 inside the lens 202 should not be taken as limiting. It is well known that an exit pupil is a conjugate of the aperture stop, and especially with infinity focus lenses, those components may equally well be placed immediately behind the infinity lens.

The joint, or gap between, or overlap of the pair of transparent components 103 and 105 is oriented approximately perpendicular to the normal plane defined by the two oculars 1220A and 1220B, or by the plane defined by the two cameras 1217A and 1217B.

That we illustrate the preferred orientation for the exit polarizing filters 104A and 104B as approximately parallel to each other, while the preferred orientation of the retarders 1219A and 1219B, if present, is approximately orthogonal to each other, is not intended to be limiting. An equal alternative is for the orientation for the exit polarizing filters 104A and 104B is to be approximately orthogonal to each other, when the orientation of the retarders 1219A and 1219B are approximately parallel to each other.

That we illustrate the preferred placement of the exit polarization filters 104A and 104B between the beam-splitter 1216 and the oculars 1220A and 1220B, or the cameras 1217A and 1217B, is not intended to be limiting. Polarizing filters can be also be mounted on, or inside, the oculars and cameras, and may also be placed over the eyes 1221A and 1221B as with polarized eye-wear, or maybe integrated with the image acquisition surface used inside cameras 2117A or 2117B.

When the entrance polarizing filter 101 and the pair of transparent components 103 and 105 are correctly oriented (in a first position or mode), a stereoscopic image is produced for viewing by the human eyes 1221A and 1221B, and for the cameras 1217A and 1217B. When the entrance polarizing filter 101 is rotated to a second different orientation (or into a second mode), either no stereo effect is produced (a 2D image is seen), or an inverse stereo (depth reversed) image is perceived. Alternatively, when the pair of transparent components 103 and 105 are rotated to a second different orientation (or into a second mode), either no stereo effect is produced (a 2D image is seen), or an inverse stereo (depth reversed) image is perceived.

As in FIG. 2, when the entrance polarizing filter 101 is correctly oriented a stereoscopic image is produced at the image plane 208. When the entrance polarizing filter is rotated to a second different orientation (or into a second mode), either no stereoscopic effect is produced, or an inverse stereoscopic (depth reversed) image is produced. When the exit polarizing filter 104 is correctly oriented a stereoscopic image is produced at the image plane 208. When the exit polarizing filter is rotated to a second different orientation (or into a second mode), either no stereoscopic effect is produced, or an inverse stereoscopic (depth reversed) image is produced. When the transparent components 103 and 105 are correctly oriented a stereoscopic image is produced at the image plane 208. When the transparent components are rotated to a second different orientation (or into a second mode) relative to the light path as indicated by dashed line 110, or relative to each other, either no stereoscopic effect is produced, or an inverse stereoscopic (depth reversed) image is produced. These relationships are further described in the following table, where, for purpose of illustration only, vertical is relative to the normal upright orientation of the lens system:

| | Transparent | | |
|---|---|---|---|
| Entrance Polarizer | Components | Exit Polarizer | Result |
| Vertical | Vertical | Vertical | 3D |
| 90 degrees | Vertical | Vertical | 2D |
| Vertical | 90 degrees | Vertical | 2D |
| Vertical | Vertical | 90 degrees | 2D |
| 90 degrees | Vertical | 90 degrees | inverted 3D |
| Vertical | 180 degrees | Vertical | inverted 3D |

That we illustrate, in the above table, with a vertical base of orientation is not intended to be limiting. Clearly, the same sequence of effects can be produced if the polarization orientation begins with the entrance polarizer vertical and the exit polarizer horizontal and the transparent components suitably oriented (90 degrees to each other). Similarly, the entrance polarizer can begin with an orientation 45 degrees to the vertical, and the exit polarizer parallel to it. In fact, almost any orientation can begin the sequence, and the same disabling of 3D to 2D can result by rotating components out of their beginning (3D ) orientation, and those skilled in the optic arts will be readily able to extend this principle to any beginning configuration.

As in FIGS. 12 and 13, when the exit polarizing filters 104A and 104B, and the retarders 1219A and 1219B are correctly oriented (or in first positions or in a first mode), a stereoscopic image is produced for viewing by the human eyes 1221A and 1221B and for the cameras 1217A and 1217B. When the exit polarizing filters 104A and 104B are rotated to second different orientations (or into a second mode), either no stereoscopic effect is produced (a 2D image is seen), or an inverse stereoscopic (depth reversed) image is perceived. Alternatively, when the retarders 1219A and 1219B are rotated to second different orientations (or into a second mode), either no stereo effect is produced (a 2D image is seen), or an inverse stereo (depth reversed) image is perceived.

That we illustrate with a simple cylinder shaped video cameras 1217A and 1217B is not intended to be limiting. Any camera may be employed in the invention, including but not limited to CCD cameras, CMOS cameras, Image Orthicon cameras, and film cameras; black and white, or color cameras; and analog or digital cameras.

That we illustrate oculars 1220A and 1220B and human eyes 1221A and 1221B, in FIG. 12, yet illustrate cameras 1217A and 1217B, in FIG. 13, is not to be taken as limiting. By interposing appropriate optical components, a single apparatus can be produced that can either switch between human and camera use, or a single apparatus can be produced that can display simultaneously for human viewing and camera recording.

The optical components 101, 103, 105, 104, 1216, and 1219 of FIGS. 1-13 are preferably sized such that at least about 90% and more preferably from about 50% to about 100% of the light passing along the optical path 110 (along which the components are positioned) passes through the components.

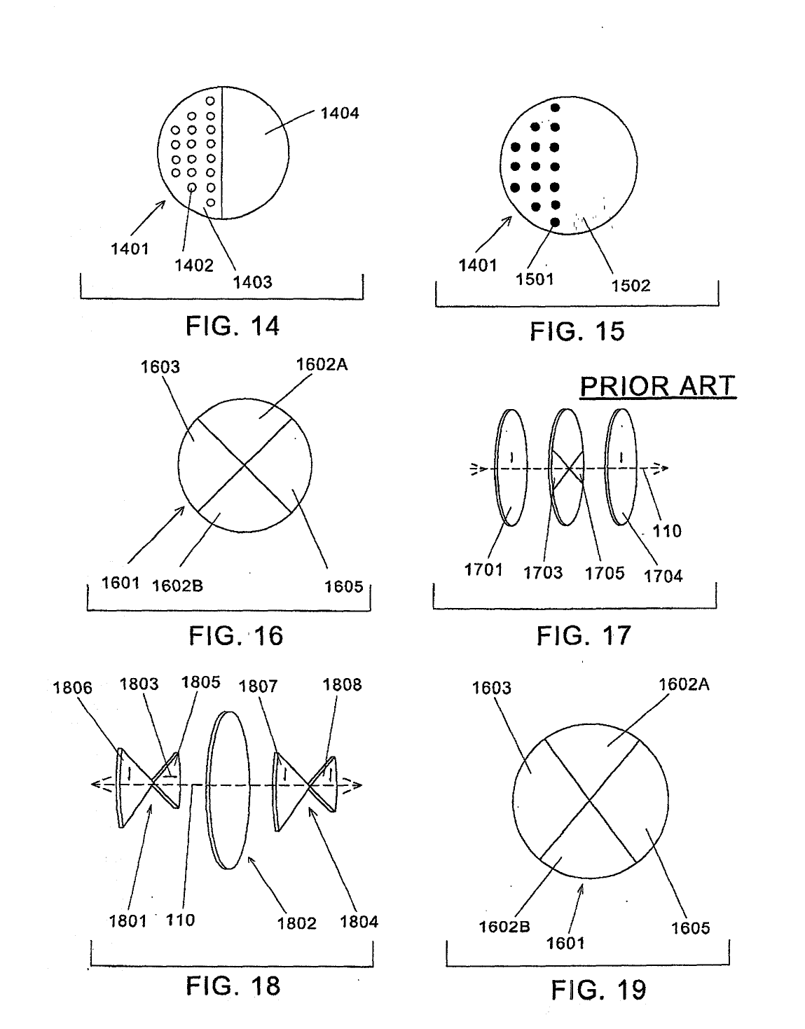

FIGS. 14 and 15 disclose methods for reducing light on one side of an aperture stop. FIG. 14 shows one method for reducing light on one side of an aperture stop that requires only passive components. The aperture-valve 1401 is created by placing an opaque (i.e., passing no more than about 1% of light in a predetermined wavelength range) or a semi-opaque (i.e., passing no more than about 15% of light in a predetermined wavelength band) material 1403 over approximately one half of the aperture stop (where the other half 1404 is either uncovered or covered with a substantially transparent substance (such as glass), and where the material 1403 is perforated with holes 1402 (or configured to include a plurality of transparent (i.e., passing at least about 99% of light in a predetermined wavelength band) or semi-transparent (i.e., passing at least about 85% of light in a predetermined wavelength band) material 1402 disposed) in some regular or irregular pattern. The area of the optical element 1401 at the aperture stop and/or transparent or semitransparent material preferably ranges from about 25% to about 75% of the area of the optical element shown in FIG. 14. The number and size of the perforations determine the amount of light that will be transmitted through the aperture stop. Typically, the amount of light transmitted through the aperture stop is at least about 50% and more typically from about 15% to about 85% of the light contacting the optical element 1401. These perforations, combined with the transmission characteristics of the material 1403 determine the amount of light reduction through the effected part of the aperture stop. That we show the perforations as regularly spaced is not intended to be limiting, because perforations can be arranged in a wide variety of patterns and/or shapes many of which can be very irregular in spacing or spread non-uniformly across the base material 1403. Any such arrangement shall still be a part of this invention. Clearly the effect of perforations can be achieved with a wide variety of manufacturing techniques, and any such technique shall still become a part of this invention. That we show all the perforations as the same is not to be taken as limiting because a variety of sizes and shapes will work equally well to effect the transmission of light through that half of the aperture stop.

FIG. 15 shows the inverse of the method shown in FIG. 14. Here the aperture-valve 1401 has a base material 1502 that covers approximately all the aperture stop. The base material may or may not effect the nature of the light transmitted through it. Approximately one half of the base material is covered with a regular or irregular pattern of shapes, where each such shape, as at 1501, fully occludes (i.e., passes no more than about 1% of light in a predetermined or selected wavelength band) or partly occludes (i.e., passes no more than about 15% of light in a predetermined or selected wavelength band) the transmission of light through it. The individual occluding shapes need not be circular, nor do they need to all be the same shape or size. Irregular shapes, sizes, and patterns will work just as well to effect the reduction of light through that effected half of the aperture stop. The area of the optical element covered by the occlusive areas is the same as that discussed above for transmissive regions.

One advantage to the occlusion or transmission of light shown by the aperture-valves shown in FIG. 14 and FIG. 15 is that of a pattern or element size that is less than the wave length of light in diameter can produce a sharpening effect over that half of the aperture stop. Such a sharpening of half the aperture stop shall also be a part of this invention. Lutz Kipp and colleagues from the Universities of Kiel and Hamburg in Germany have shown that pin holes covering the entire aperture stop can sharpen the image produced.

FIGS. 16-22 disclose an improved stereoscopic aperture-valve. Shown diagrammatically in FIG. 16 is an improved stereoscopic aperture-valve capable of insertion into the aperture stop of any imaging lens system to enable that lens system to produce stereoscopic video, still, or motion picture image sequences, also called “frame sequential” images. This improved stereoscopic aperture-valve can be retrofitted into any existing lens system and can be manufactured into any new lens system. Examples of such lens systems include microscopes, endoscopes, video lenses, still camera lenses, ocular fundus lenses, inspection lenses, video lens adapters, still camera lens adapters, binocular adapters, monocular adapters, and motion picture lenses. Although these examples are the only ones cited, they are not intended to be limiting. Any imaging lens system can be used to exploit this improved stereoscopic aperture-valve and such unforeseen applications are considered a part of this embodiment.

The improved stereoscopic aperture-valve is capable of producing a sequence of images that can later be viewed in 3D, also called stereovision or human stereopsis. FIG. 16 illustrates diagrammatically one form of such an improved stereoscopic aperture-valve.

FIG. 16 shows one form of an aperture-valve 1601 similar to that of FIG. 9 discussed above. The alternation of occlusion between the right and left sides of the aperture stop are handled by the sections 1603 and 1605 where section 1603 is made opaque while section 1605 is made transparent. The roles of sections 1603 and 1605 are then reversed for the next image in a sequence of images (See FIGS. 39-40). The top and bottom sections 1602A and 1602B are left fully or partially transparent (i.e., passing at least about 98% of light in a predetermined or selected wavelength band) regardless of the states of sections 1603 and 1605.

FIG. 17 shows a PRIOR ART stereoscopic light valve in exploded form. The entrance polarizing filter 1701 and the exit polarizing filter 1704 both cover the entire light path (as indicated by dashed line 110) of the lens system. Sections 1703 and 1705 are shaped to cover only approximately the left and right quarters of the aperture stop. The left side 1703 is separately controlled from the right side 1705. In this arrangement, the polarizing layers 1701 and 1704, that cover the entire light path, cause light loss through the system of typically 85% or more of the light's original intensity.

FIG. 18 shows FIG. 16 in exploded form. FIG. 18 details a method that significantly improves the light transmitted through a typical aperture light valve. The retarder layer 1802 covers the entire light path 1810 of the lens system (i.e., at least about 98% of the light passing along the optical path passes through the light valve), and its retardation is controlled electrically by wires (not shown). The retardation layer 1802 (unlike 1703 and 1705 in FIG. 17) is not divided into sections, but is rather one single switched section. As a method to decrease the light loss through the system, the entrance polarizer 1801 is shaped to cover approximately two quadrants of the aperture stop. As a further method to decrease the light loss through the system, the exit polarizer 1804 is shaped to approximately match the shape of the entrance polarizer 1801. The dashed line 1810 shows that the image light can pass in either direction through this filter with no change in effect. Each of the entrance and exit polarizing filters 1801 and 1804 of FIG. 18 are preferably sized such that they cover about 55% and more preferably from about 45% to about 80% of light passing along the optical path (of which the components are a part) that passes through the polarizers. As indicated by symbol 1803 in FIG. 18, the polarizer 1801 comprises transversely polarized quadrants 1805 and 1806. In the polarizer 1804, each of the quadrants 1807 and 1808 have their polarization direction oriented in parallel. When both the entrance and exit polarizing filters are shaped to occupy approximately half the light path in approximately quarters, the light loss through the system is significantly reduced to less than one f-stop, or to less than 50%.

FIG. 19 shows the front or axial view of the filter shown in FIG. 18. FIG. 19 shows an aperture stop in a lens system 1601, where the left quadrant 1603 covers greater than approximately one-quarter and typically from about 20% to about 35 % of the aperture stop, and where the right quadrant 1605 covers greater than approximately one quarter and typically from about 20% to about 35% of the aperture stop. Stated another way, the left and right quadrants each encode at least about 30% and more typically from at least about 20% to about 35% of the light passing through the aperture stop along the optical path. The two quadrants are constructed as in FIG. 18, where the entrance polarizer 1801 and exit polarizer 1804 are shaped similar to each other and cover only the quadrants indicated by 1603 and 1605 of FIG. 19. When one quadrant 1603 is made opaque and the other quadrant 1605 is made light transmissive, or the reverse, and when quadrants 1602A and 1602B are always transparent, the light loss through the system is 37.5% of the original light's intensity. Clearly light loss of 37.5% of the original light's intensity (less than one f-stop) is a significant improvement over a light loss of 85% or greater of the original light's intensity (two or more f-stops).

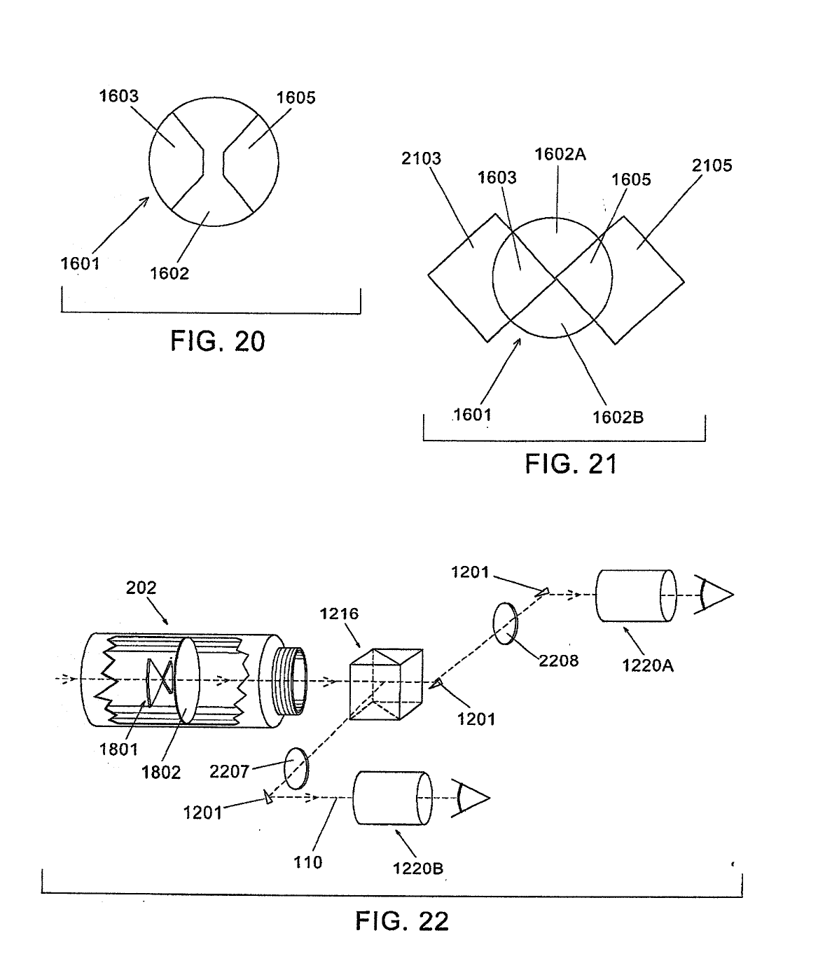

That we speak of quadrants is not to be taken as limiting. As shown in FIG. 20, a light valve 1601 can be created where the transparent areas 1602A and 1602B of FIG. 19 are combined into a single clear area 1602 of FIG. 20. The left area 1603 is made opaque while the right area 1605 is made transparent, then the relationship is reversed. Clearly, any shapes can be used with this method, and all such shapes shall be a part of this patent.

That we speak of transparent is not to be taken as limiting. It is well known that liquid crystals typically reduce light transmission by about 2%. Clearly that we speak of transparent can be reasonably construed to include transmission reductions that range from truly transparent (0% light loss) to near transparent (25% light loss) and will still be considered a part of this embodiment.

That we imply photo-lithographically shaped areas is not to be taken as limiting. As shown in FIG. 21, the aperture stop of a lens system 1601 is divided into quadrants. The left quadrant 1603 is created by interposing part of a rectangular liquid-crystal switch 2103 diagonally into the aperture stop. The right quadrant 1605 is created by interposing part of a rectangular liquid-crystal switch 2105 diagonally into the aperture stop. The top and bottom quadrants 1602A and 1 602B are either left open or filled with clear glass to equalize the length of the optical paths among all the quadrants. As depicted, the diagonals of the switches intersect one another at a point in the center of the aperture 1601, and are at least substantially parallel and collinear.

Referring to FIG. 18, the improved aperture-valve is preferably constructed as thin as necessary to avoid space conflict with any lens elements that surround the aperture stop or conjugate of the aperture stop. The improved aperture-valve is at or near the aperture stop or at or near a conjugate of the aperture stop. When there is not sufficient room for all the components at the aperture stop, only the entrance polarizer 1801 (relative to the direction of light through the system 110, i.e. if the light direction is reversed, then the entrance polarizer would be 1804) is required to be at the aperture stop, or at the conjugate of the aperture stop. That we show both quadrants of the entrance polarizer 1801 (or 1804 if light direction is reversed) at the same aperture stop should not be taken as limiting. One quadrant may be at one aperture stop or conjugate, and the second quadrant maybe at a second aperture stop or conjugate, provided both quadrants are prior in the light path to both the retarder 1802 and the exit polarizer 1804 (or 1801 if light direction is reversed).

That we specify a single shape at any given time is not intended to be limiting. Because some shapes may be more suitable than others for the rendering of 3D for different objects, different shapes may be used over time or simultaneously to best render a scene or components of a scene. Although less desirable in the physical world, such custom tuning to individual scene objects is highly desirable in software implementations.

That we do not specify achromatic components is not intended to be limiting. Achromatic components are necessary in applications where the true rendering of visual colors is desirable, but are not necessary where such renderings are not necessary, as in black and white imaging. Clearly those skilled in the optic arts will be readily able to select the most desirable quality of components based on specific application requirements, and any such selection shall be considered a part of this invention.

That we specify that the image is occluded sequentially on one half of the aperture stop, and then the other half of the aperture stop, is not intended to be limiting. As shown in FIG. 22, when the entrance polarizer quadrants 1801 have different polarization orientations from each other (such as shown in FIG. 18), it becomes possible to pass the result through an optional retarder 1802, a beam splitter (or birefringent element) 1216, and to place differently oriented exit polarizers 2207 and 2208 ahead of each of a pair of oculars 1220A and 1220B or cameras (representable by 1220A and 1220B), or both. The entrance polarizer quadrants 1801 are placed at the aperture stop, or a conjugate of the aperture stop, of lens system 202. The direction of light through the system is indicated by dashed line 110.

That we specify occlusion is not intended to be limiting. Full occlusion is neither necessary nor desirable. In actual practice it is only necessary to significantly reduce the image light passing through a quadrant of the aperture stop. A reductive difference between the occluding and transmitting halves of the aperture stop of only three f-stops has been found to be sufficient to produce acceptable 3D. Greater occlusion is necessary when low contrast image are viewed or recorded. Preferably, the difference in light transmission is at least about 87.5%, and preferably ranges from about 75% to about 99%.The retarder, when it is a liquid crystal, may also be powered with a reduced (or negative) voltage, which will also have the effect of reducing its polarization retardation and thus reducing its occluding effect.

The mirrors or prisms 1201 are arranged so that the images projected to the human eyes are roughly parallel and spaced appropriately for human viewing. The polarizing filters 2207 and 2208 may appear on either side of the mirrors or prisms 1201, or between them. When oculars 1220A and 1220B are instead cameras, the mirrors 1201 maybe omitted or included in a different manner.

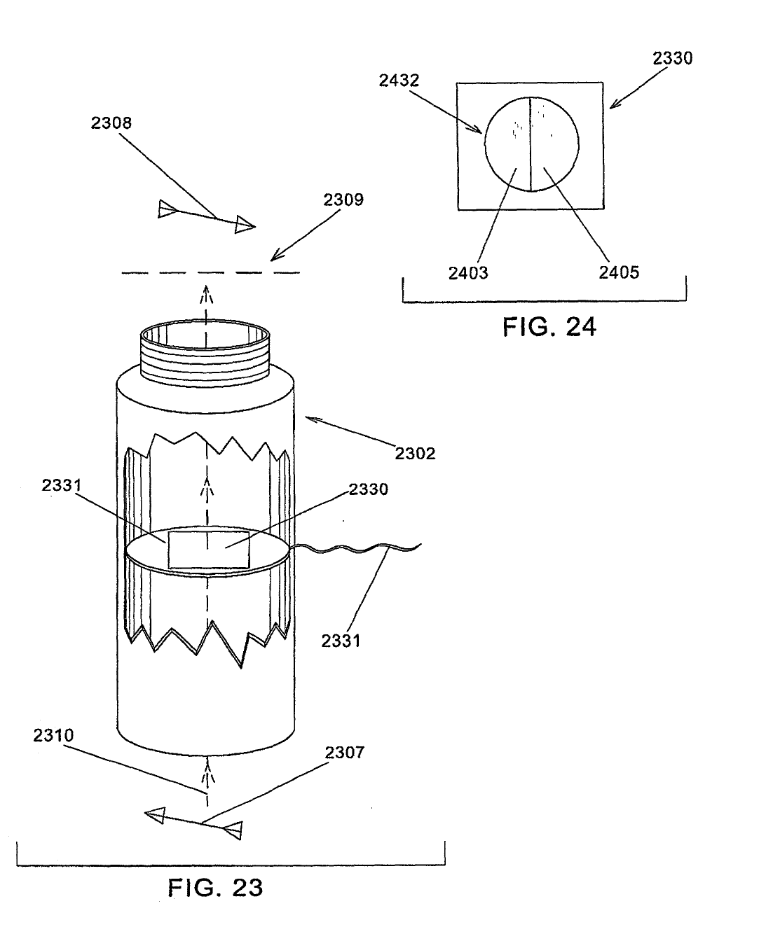

FIGS. 23-38 disclose a digital iris.

A normal iris is usually constructed of mechanical parts that reduce or increase the diameter of the light path through the aperture stop of a lens system. A much improved iris can be constructed using liquid crystal switching, fero-electric liquid crystal switching, or transmissive micro-display technologies.

Shown in FIG. 23 is a digital iris capable of insertion into the aperture stop, or any conjugate of the aperture stop, of any imaging lens system to enable that lens system to adjust the light passing through the aperture stop. One application for such a digital iris is to condition the aperture stop to produce the most pleasing image possible in video, still, or motion picture photography. Another application for such a digital iris is to produce stereoscopic video, still, or motion picture image sequences. Another application for such a digital iris is to produce optical effects that display in the out-of-focus areas of the image. Another application for such a digital iris is to insert images or text into the image that can only be viewed in the out-of-focus areas, and that can be regenerated by projecting the resultant image back through and optical lens system and displaying the Fourier transform of the image at the aperture stop. Such displays and effects apply to both analog and digital image capture but not to image display.

The digital iris can be retrofitted into any existing lens system and can be manufactured into any new lens system. Examples of such lens systems include microscopes, endoscopes, video lenses, still camera lenses, ocular fundus lenses, inspection lenses, video lens adapters, still camera lens adapters, binocular adapters, monocular adapters, and motion picture lenses. Although these examples are the only ones cited, they are not intended to be limiting. Any imaging lens system can be used to exploit this transparent stereoscopic aperture-valve and such unforeseen applications are considered a part of this embodiment.

The digital iris component 2330 is constructed as thin as necessary to avoid space conflict with any lens elements that surround the aperture stop. The digital iris is placed at or near the aperture stop, or at or near a conjugate of the aperture stop.

The digital iris can be constructed from any of: liquid crystals with entrance and exit polarizing materials; liquid crystals with either or both of the entrance and exit polarizing materials omitted; fero-electric liquid crystals with entrance and exit polarizing materials; fero-electric liquid crystals with either or both of the entrance and exit polarizing materials omitted; transmissive micro-displays with entrance and exit polarizing materials; or transmissive micro-displays with either or both of the entrance and exit polarizing materials omitted. That we speak of liquid crystals, fero-electric liquid crystals, or transmissive micro-displays should not be taken as limiting, because any electronic method conditioning the transmission of light through an aperture stop will also function as a digital iris, and should still be considered a part of this embodiment.

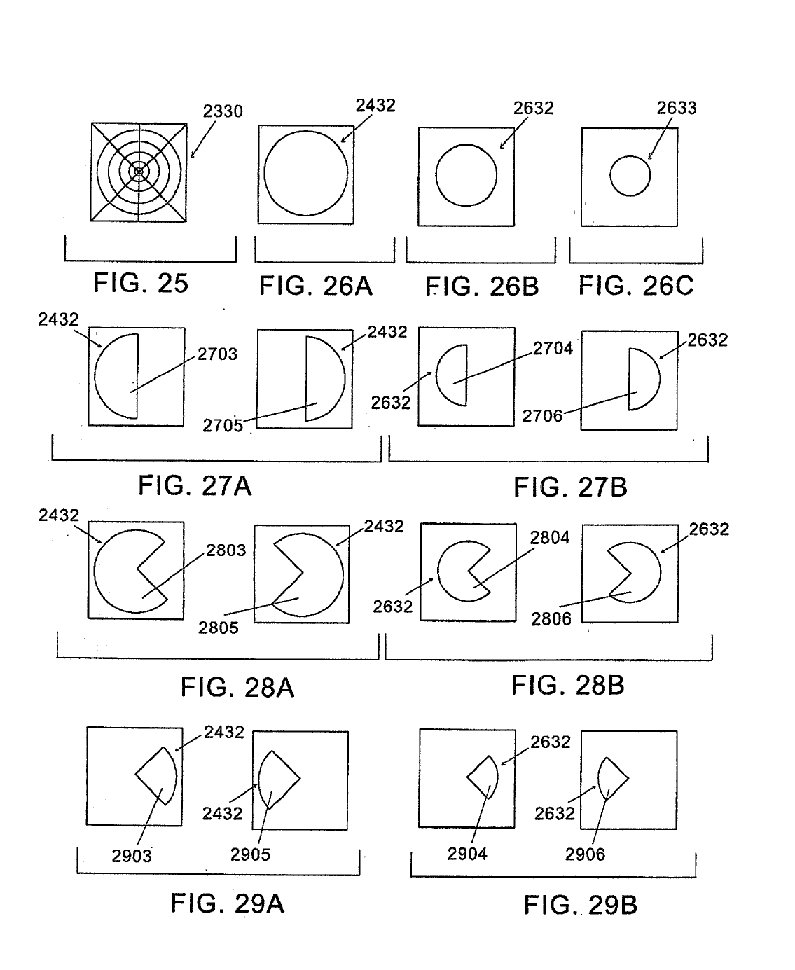

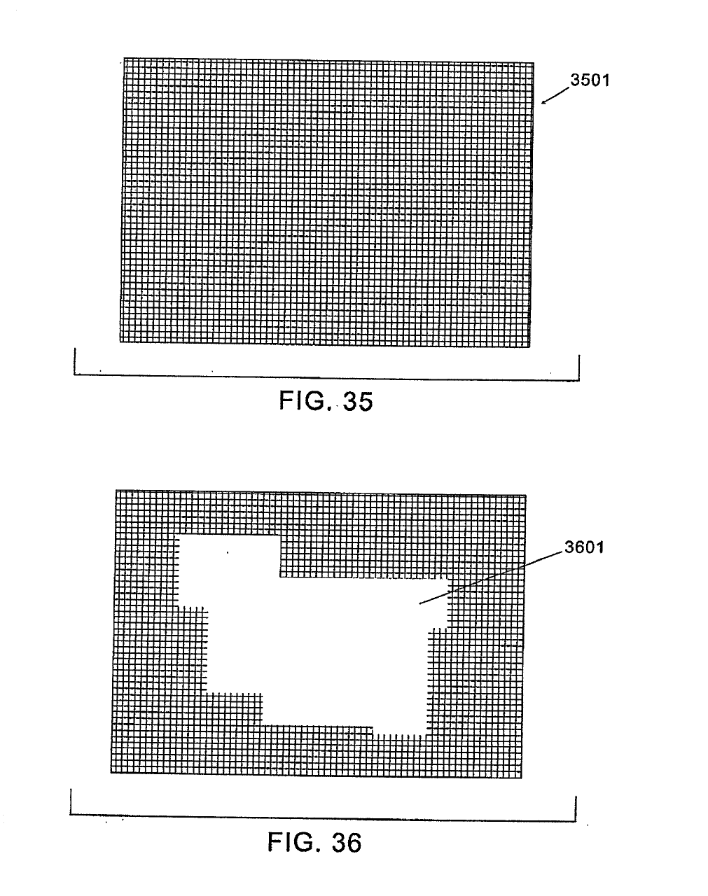

FIG. 23 shows the two components that form a digital iris. The encoding portion 2330 is typically surrounded by a partially flexible structure 2331 which provides electrical connections to the encoding portion. The number of electrical connections is determined by the number of pixels that need to be addressed within the encoding portion. Less complex encoding portions, as at 2330 of FIG. 25, will require fewer electrical connections. More complex encoding portions, as at 3501 of FIG. 35, will require more electrical connections.

FIG. 23 also shows placement of a digital iris into a lens system. A lens system 2302 gathers the light from a subject 2307 and projects an image of that subject onto a new image plane 2308. The image plane 2308 is the image plane of a typical camera, the body of which is represented by dashed line 2309, and is the front surface of an Image Orthicon tube, a CCD array, CMOS array, positive film, negative film, or any other image recording surface. The camera is analog or digital. The dashed line 2310 shows the direction of light through the lens system.

The digital iris 2330 is placed at the aperture stop of the lens system. Electrical connection to the digital iris is made through the support and electrical connections of the digital iris 2331 that are a part of the digital iris's housing.

FIG. 24 shows two effects that can be produced by a digital iris 2330, either simultaneously or sequentially. A circular transmissive area 2432 can vary in diameter, thereby providing a direct replacement function for a mechanical iris. In time sequence, first one side, 2403 or 2405, can be occluded or made transmissive, then the other side can be occluded or made transmissive to produce a time sequential stereoscopic effect. In time parallel, the two sides 2403 and 2405 can be subtractively or additively tinted (colored) to render an anaglyphic image (i.e., side 2303 could pass all colors except for blue, and side 2305 could pass all colors except for yellow, or side 2303 could pass all colors except for red, and 2305 could pass all colors except for cyan). All of these effects, and others to be disclosed, may be time sequenced or performed simultaneously, or any of these effects may be produced alone.

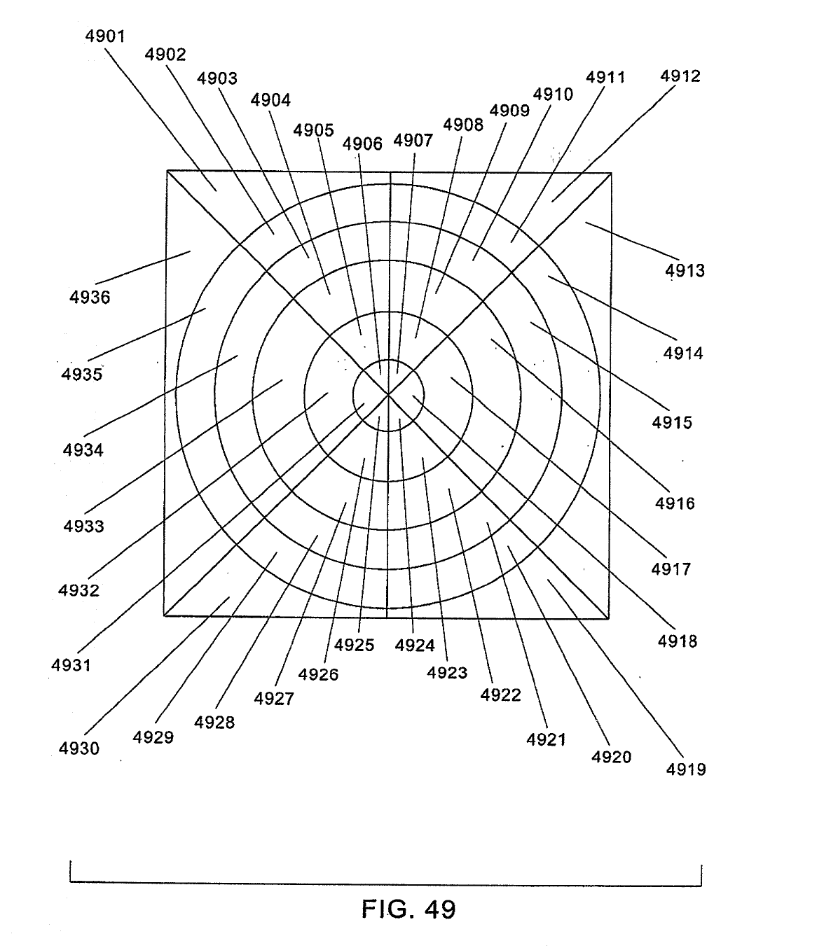

FIG. 25 shows one way to arrange pixels on the digital iris to achieve both light regulation and a frame sequential stereoscopic effect. FIG. 49 shows that same arrangement with the pixels numbered for clarity in the following discussion. Each of the pixels can be made fully or partially transmissive or fully or partially opaque individually. For example, pixel 4901 is transmissive when pixel 4902 is opaque and vice versa. Such an arrangement as shown would require about thirty-seven electrical connections (one for each pixel, and one for a common ground) to control it. FIGS. 26A, 26B, and 26C (in that order) show progressive steps (sequence) of reducing the size of the digital iris's transmissive portion, that reduces the light passing through the aperture stop, where 2432 is the circular opening that resembles the shape produced by mechanical irises. The circular opening 2432 of FIG. 26A is produced by occluding pixels 4901, 4912, 4913, 4919, 4930, and 4936, while leaving all the other pixels transmissive. The smaller circular opening 2632 of FIG. 26B is produced by occluding (in addition to the pixels listed for FIG. 26A) pixels 4902, 4911, 4914, 4920, 4929, and 4935. The yet smaller circular opening 2633 of FIG. 26C is produced by occluding (in addition to the pixels listed for FIGS. 26A and 26B) pixels 4903, 4910, 4915, 4921, 4928, and 4934. A yet smaller opening is produced by occluding (in addition to the pixels listed for FIGS. 26A, 26B, and 26C) pixels 4904, 4909, 4916, 4922, 4927, and 4933.

When the sequence progresses in the opposite order (i.e., in the order FIGS. 26C, 26B, and then 26A) the amount of light passing through the aperture stop is increased as the size of the opening increases from small opening 2633 of FIG. 26C to large opening 2432 of FIG. 26A.

FIG. 27A shows two frame sequential configurations of the digital iris. Here the iris 2432 is open wide (as in FIG. 26A), and first one side 2703, then the other side 2705 is allowed to pass light resulting in a fame sequential stereoscopic series of images. The first side 2703 is produced by occluding (in addition to the pixels listed for FIG. 26A) pixels 4907, 4908, 4909, 4910, 4911, 4914, 4915, 4916, 4917, 4918, 4920, 4921, 4922, 4923, and 4924. Then side 2703 has those additional pixels de-occluded, and side 2705 is produced by occluding (in addition to the pixels listed for FIG. 26A) pixels 4902, 4903, 4904, 4905, 4906, 4931, 4932, 4933, 4934, 4935, 4925, 4926, 4927, 4928, and 4929.

FIG. 27B shows the same frame sequential sides as in FIG. 27A, but with the diameter of the iris 2632 reduced to reduce the overall amount of light passing through the aperture stop. The first side 2704 is produced by occluding (in addition to the pixels listed for FIGS. 26A and 26B) pixels 4907, 4908, 4909, 4910, 4915, 4916, 4917, 4918, 4921, 4922, 4923, and 4924. Then side 2704 has those additional pixels de-occluded, and side 2706 is produced by occluding (in addition to the pixels listed for FIGS. 26A and 26B) pixels 4903, 4904, 4905, 4906, 4931, 4932, 4933, 4934, 4925, 4926, 4927, and 4928.

FIG. 28A shows two more frame sequential configurations of the digital iris. Here the iris 2432 is open wide and first one side 2803, then other side 2805 is allowed to pass light resulting in a frame sequential stereoscopic series of images. Here the first and second shapes are constructed to be fully or partially opaque (when energized or de-energized) while allowing at least about 75% of the light to pass through the remaining three-quarters of the aperture stop, thereby exaggerating the stereoscopic result. FIG. 28B shows the same frame sequence, but with the diameter of the iris 2632 reduced to further reduce the overall amount of light passing through the aperture stop In FIG. 28A, the first side 2803 is produced by occluding (in addition to the pixels listed for FIG. 26A) pixels 4914, 4915, 4916, 4917, and 4918. Then side 2803 has those additional pixels de-occluded, and side 2805 is produced by occluding (in addition to the pixels listed for FIG. 26A) pixels 4931, 4932, 4933, 4934, and 4935.

FIG. 28B shows the same frame sequential sides as in FIG. 28A, but with the diameter of the iris 2632 reduced to further reduce the overall amount of light passing through the aperture stop. The first side 2804 is produced by occluding (in addition to the pixels listed for FIGS. 26A and 26B) pixels 4915, 4916, 4917, and 4918. Then side 2804 has those additional pixels de-occluded, and side 2806 is produced by occluding (in addition to the pixels listed for FIGS. 26A and 26B) pixels 4931, 4932, 4933, and 4934.

FIG. 29A shows two more frame sequential configurations of the digital iris. Here the iris 2432 is open wide and first one side 2903, then other side 2905 is allowed to pass light resulting in a frame sequential stereoscopic series of images. Here the first and second shapes are constructed to allow light through quarters of the aperture stop, decreasing the stereoscopic result. The first side 2903 is produced by occluding pixels 4901 through 4913, and pixels 4919 through 4936. Then side 2903 has those pixels de-occluded, and side 2905 is produced by occluding pixels 4901 through 4930, and 4936.

FIG. 29B shows the same frame sequential sides as in FIG. 29A, but with the diameter of the iris 2632 reduced to further reduce the overall amount of light passing through the aperture stop. The first side 2904 is produced by occluding (in addition to the pixels listed for FIG. 29A) pixel 4914. Then side 2904 has those additional pixels de-occluded, and side 2906 is produced by occluding (in addition to the pixels listed for FIG. 29B) pixel 4935.

The normal shape of an iris is circular. This would be of no consequence if all captured images were round. In actual practice, images are almost always captured on square or rectangular shaped surfaces. Television, for example, captures and displays images on a rectangle with proportions of 1:1.22, whereas many motion pictures are captured on a rectangle with proportions of 1:1.85. When a round iris is used to reduce the light passing through an aperture stop that will later image on a rectangular shaped imaging surface, the result is a loss of resolution in the comers of the rectangle.

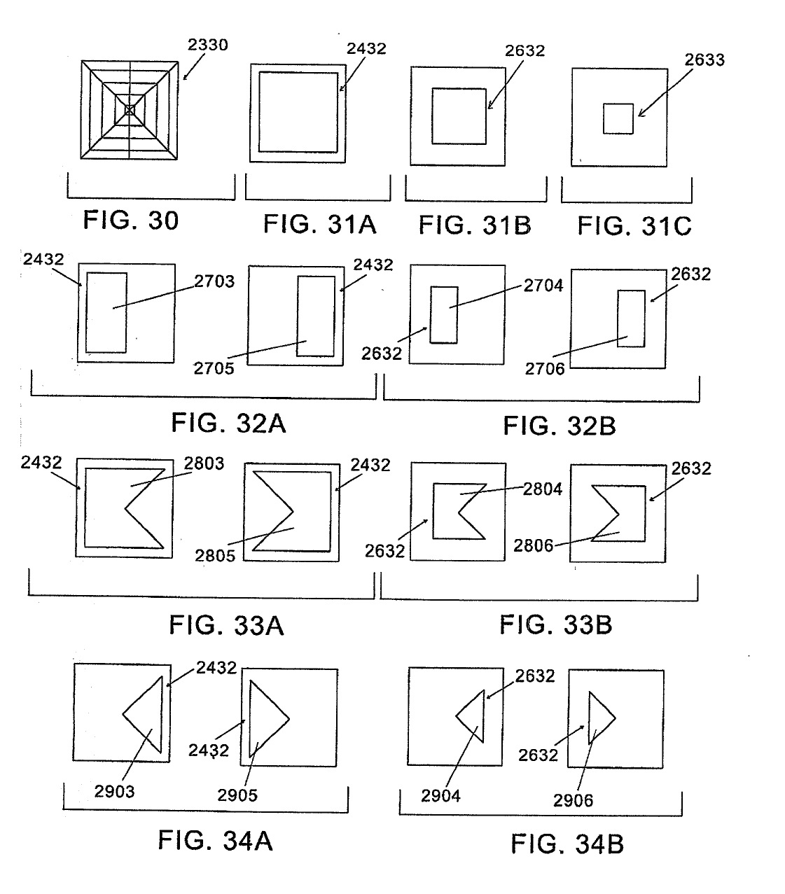

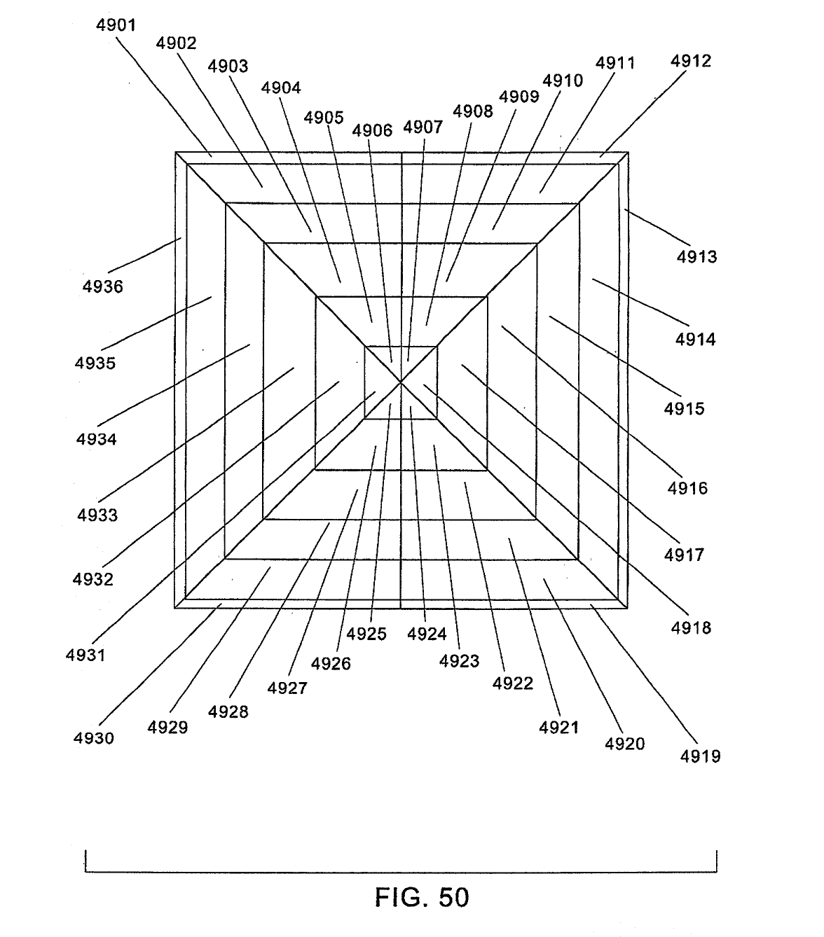

FIG. 30 shows one arrangement of pixels for a digital iris that solves the problem of resolution loss. Instead of the pixels being based on circular shapes, as in FIGS. 25-29B, they are based on rectangular shapes. FIGS. 30-34B show the same examples as do the corresponding figure FIGS. 25-29B, and the same description applies including pixel numbering (as shown in FIG. 50).

That we illustrate rectangular and round irises should not be taken as limiting. Clearly rectangles can be constructed with rounded corners and circles can be constructed as ovals or ellipses. In fact, varying sizes of other geometric and non-geometric shapes will work as well. Triangles or stars, for example, will sharpen the out-of-focus areas of resulting image. Leaf or fish shapes, just to list a few, can also find useful application in selected categories of captured images.

One advantage of the mechanical iris is that it is continuously variable, and therefore can produce a nearly unlimited number of iris diameters, or f-stop settings. FIG. 35 shows the preferred embodiment, a digital iris 3501 that is composed of many more pixels than are shown in FIG. 25 or FIG. 30. When the number of rectangular pixels is 128×128

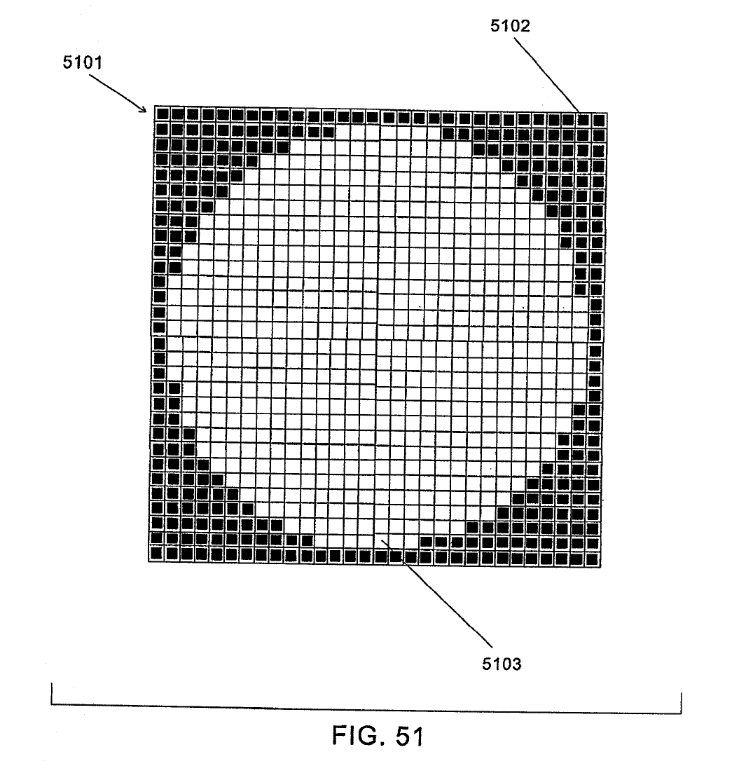

(128 pixels per side), sixty-four distinctly different sized square iris opening are possible. When the number of rectangular pixels is 768×1040 (the usual VGA proportions) 384 distinctly different sized square iris openings are possible. FIG. 51 shows a 30×30 pixel digital iris 5101 that has some pixels set to block the transmission of light, as at 5102, and some pixels set to transmit light, as at 5103. It is clear from this figure that a true circle can be approximated by such a 30×30 digital iris, and it is easily inferred that as the number of pixels increases the approximation will come closer to a true circle.

The number of levels of light transmission can be increased by not using precisely rectangular shapes. FIG. 36 shows a much exaggerated non-rectangular shaped opening 3601 that reduces the light allowed through the aperture stop. By employing non-rectangular shapes, the range or number of light transmission levels can be increased to approximate that of the mechanical iris.

In general, the shape of the iris should match the shape of the eventual image captured. A square iris maybe most beneficial for a 2¼″2¼″ still camera format. A rectangle in the ratio 1:1.22 may be most beneficial for a video camera which captures in broadcast format. And a ratio of 1:2.35 maybe most beneficial for anamorphic motion picture cameras. If a circular based iris is preferred by the photographer or camera person, an ellipse with appropriate proportions may be best. The digital iris lends itself to a wide range of choices, and is clearly superior to a mechanical iris in that regard.

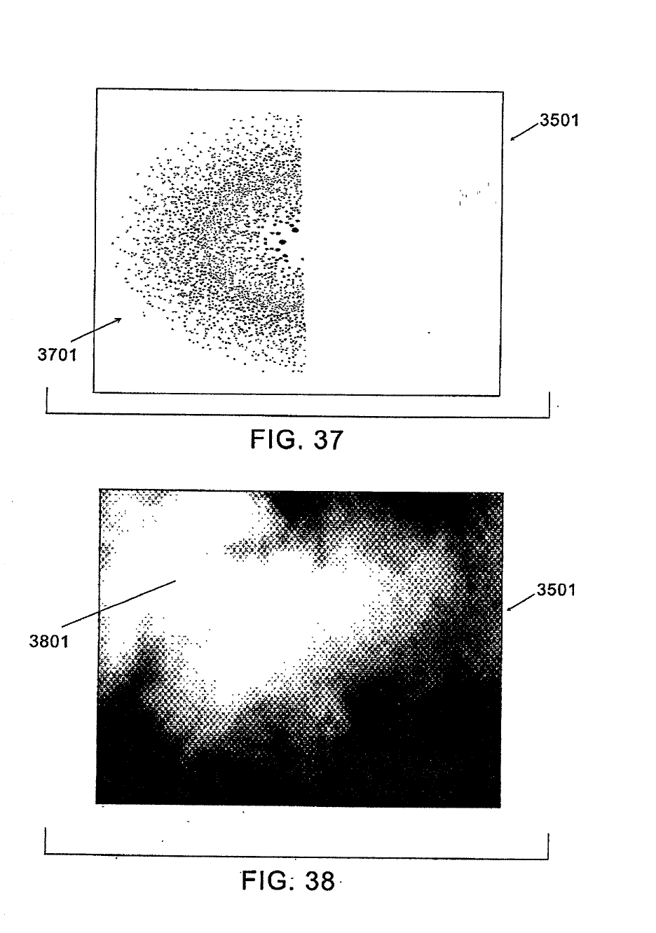

FIG. 37 shows that with VGA resolution, or higher density pixel arrays, very complex patterns of occlusion can be achieved. Here a complex pattern 3701 is shown on one side of the digital iris 3501, as would be the case if one of a sequence of frame sequential stereoscopic images was being captured using such a complex pattern.

Silicon on insulator semiconductors as a basis for a transmissive micro-display is the preferred implementation, and can produce high contrast, occlude or transmit only pixels. It is also well known that such transmissive micro-displays can also produce a number of gradations of light transmission. The effect for such gradations would be to also allow imposition of images or textures over the aperture stop. FIG. 38 shows one such texture imposed over the aperture stop. The texture, illustrated in 3801, is of clouds or fog. Such a texture, byway of example, may soften an image taken in rain, and make the out-of-focus areas appear fog-like.

Transmissive micro-displays can also produce color pixels as well as grey scale pixels. Color can be combined with the iris effects to tint a scene and to vary that tint over time. Color can also be combined with the iris to color-correct or to white-balance in extreme or unusual lighting situations. Color can also be combined with the iris, one tint on one side, and a compliment tint on the other, to produce an anaglyphic stereoscopic image.

The difference between a liquid crystal aperture valve and a transmissive micro-display occurs in the handling of an individual pixel. In the liquid crystal aperture valve, each pixel is powered, de-powered, or inversely powered directly by conductors. As the number of pixels in a rectangular array increases, the ease of connecting conductors to pixels decreases, and complexity of manufacture increases. In a micro-display, each pixel is provided with constant power. The state of a pixel is altered (toggled or gated) by a semiconductor (transistor) associated with it and at least a TTL signal to that semiconductor control. A transmissive micro-display is capable of a significantly higher pixel count and density compared to a liquid crystal aperture valve. Higher density allows for significantly finer control of the aperture opening.

Those skilled in the optic arts will readily be able to create such a digital iris from existing products. Kopin Corporation, for example, makes a Cyberdisplay 640 Color transmissive micro-display that could be suitable for use as a color digital iris, with a 640×480 array of rectangular pixels. CRL Opto, Inc., for example, makes an XGA1 black/white transmissive micro-display that could be suitable for use as a black/white digital iris, with a 1024×760 array of rectangular pixels.

That we speak of silicon on insulator technologies as the preferred basis for transmissive micro-displays to be used at the aperture stop is not intended to be limiting. It is well known that transmissive micro-displays can be based on a number of other technologies. Liquid crystal arrays are common. High temperature poly-silicon on quartz can also be used, as can low temperature poly-silicon when that technology matures. The underlying method is to use a large number of transmissive pixels at the aperture stop, or a conjugate of the aperture stop, to control the amount of light passing through the aperture. In addition to controlling light, such an iris can also control alternating sides of the iris to generate frame-sequential 3D. Such an iris can also be used to effect color over all or part of the aperture stop. The greater the number of pixels, the higher the resolution and the finer the control over the aperture stop. Clearly, high resolution, control of color, and control of grey-scale are chief concerns when implementing such an iris, and all such variations are hereby included in this patent and disclosure.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g. for improving performance, achieving ease and\or reducing cost of implementation.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system for producing, from a received imaging signal containing image information relating to an object, a three-dimensional image of the object in a first mode and a two-dimensional image of the object in a second mode, comprising:
at least a first encoder operable to encode the received imaging signal to produce at least an encoded first imaging signal;
at least a second encoder, positioned at or near at least one of an aperture stop and a conjugate thereof, operable in the first mode to encode differently portions of the first imaging signal to produce at least second and third imaging signal portions; and
at least a third encoder different from the at least a second encoder, the third encoder being operable to encode the second and third imaging signal portions, wherein in a first mode the first, second, and third encoders are configured to output second and third imaging signal portions having at least one differing optical characteristic and in a second mode the first, second, and third encoders are configured to output second and third signal portions in which the at least one differing optical characteristic is at least substantially the same.

2. The system of claim 1, wherein the optical characteristic is at least one of wavelength distribution, intensity, polarization orientation, and phase.

3. The system of claim 1, wherein the at least a second encoder is electrically switched and is one or more liquid crystals, rotating polarizers, polarization rotator, Pi cells, and combinations thereof.

4. The system of claim 1, wherein the first and third encoders are each at least one of an a reflector or mirror, an achromatic filter, a chromatic filter, an anaglyphic filter, a polarizing filter, a retarder, an occluder, a rotating polarizer, a polarization rotator, and a shutter.

5. The system of claim 1, wherein in the first mode the first, second, and third encoders are in the optical path and in the second mode at least one of the first, second, and third encoders are not in the optical path.

6. The system of claim 1, wherein the at least one optical characteristic is polarization, in the first mode the polarization orientations of the second and third signal portions are transverse and in the second mode the polarization orientations of the second and third signal portions are at least substantially parallel.

7. The system of claim 1, wherein the at least a second encoder is at least one of transversely oriented wave retarders, transversely oriented polarization retarders, and alternately energized polarization retarders.

8. The system of claim 7, wherein the at least one of transversely oriented wave retarders, transversely oriented polarization retarders, and alternately energized polarization retarders are in an at least substantially non-overlapping relationship.

9. The system of claim 1, wherein the polarization orientations of the at least a first and the at least a third encoders are one of at least substantially parallel, orthogonal, and offset by 45 degrees.

10. The system of claim 1, wherein the at least a second encoder is passive and the at least a third encoder comprises at least two retarders and further comprising a signal director operable to direct the second and third imaging signal portions along spatially distinct second and third optical paths, respectively, wherein at least one retarder is positioned along each of the second and third optical paths.

11. The system of claim 1, wherein the system comprises a lens system, wherein the first and third encoders are located outside the lens system, and wherein the second encoder is located within the lens system.

12. The system of claim 1, further comprising:
a lens at an optical input of an adapter configured to receive an imaging signal;
a relay lens system in the adapter configured to form the received imaging signal a conjugate of an aperture stop for the received imaging signal and wherein the at least a first encoder is positioned at or near the optical input of the adapter and the at least a third encoder is positioned at or near an optical output of the adapter.

13. A method for producing, from a received imaging signal containing image information relating to an object, a three-dimensional image of the object in a first mode and a two-dimensional image of the object in a second mode, comprising:
encoding the received imaging signal to form at least an encoded first imaging signal;
passing the first imaging signal through at least one encoder, positioned at or near at least one of an aperture stop and a conjugate thereof, to encode differently portions of the first imaging signal and form at least second and third imaging signal portions; and
further encoding the second and third imaging signal portions, wherein, during a selected time interval, in a first mode the second and third imaging signal portions have at least one differing optical characteristic and in a second mode the at least one differing optical characteristic of the second and third signal portions is at least substantially the same.

14. The method of claim 13, wherein the optical characteristic is at least one of wavelength distribution, intensity, polarization orientation, and phase.

15. The method of claim 13, wherein the passing step comprises;
during a first time interval, at least one of energizing, de-energizing, and reversely energizing a first portion of the at least one encoder and another of the at least one of energizing, de-energizing, and reversely energizing a second, different portion of the at least one encoder; and
during a second, later time interval, at least one of energizing, de-energizing, and reversely energizing the second portion of the at least one encoder and another of the at least one of energizing, de-energizing, and reversely energizing the first portion of the at least one encoder.

16. The method of claim 15, wherein the passing step comprises;
during a first time interval, passing at least most of the second imaging signal portion but not at least most of the third imaging signal portion; and
during a second, later time interval, passing at least most of the third imaging signal portion but not at least most of the second imaging signal portion.

17. The method of claim 13, wherein in the first mode the first, second, and third encoders are in the optical path and in the second mode at least one of the first, second, and third encoders are not in the optical path.

18. The method of claim 13, wherein the at least one optical characteristic is polarization, in the first mode the polarization orientations of the second and third signal portions are transverse and in the second mode the polarization orientations of the second and third signal portions are at least substantially parallel.

19. The method of claim 13, wherein the at least one optical characteristic is intensity.

20. The method of claim 13, wherein the second and third imaging signal portions are each formed from about 25% to about 50% of the first imaging signal.

21. The method of claim 19, wherein during a first selected time interval in the first mode the second imaging signal portion is at least about 43.5% of the first encoded signal and the third imaging signal portion is no more than about 16.5% of the first encoded signal and during a second later selected time interval in the second mode the third imaging signal portion is at least about 43.5% of the first encoded signal and the second imaging signal portion is no more than about 16.5% of the first encoded signal.

22. A system for producing, from a received imaging signal containing image information relating to an object, a three-dimensional image of the object in a first mode and a two-dimensional image of the object in a second mode, comprising:
first encoding means for encoding the received imaging signal to produce at least an encoded first imaging signal;
second encoding means, positioned at or near at least one of an aperture stop and a conjugate thereof, for encoding differently portions of the first imaging signal to produce at least second and third imaging signal portions; and
third encoding means for encoding the second and third imaging signal portions, wherein, during a selected time interval, in a first mode the first, second, and third encoding means are configured to output second and third imaging signal portions having at least one differing optical characteristic and in a second mode the first, second, and third encoding means are configured to output second and third signal portions in which the at least one differing optical characteristic is at least substantially the same.

23. The system of claim 22, wherein the optical characteristic is at least one of wavelength distribution, intensity, polarization orientation, and phase.

24. The system of claim 22, wherein the second encoding mans is electrically switched and is one or more liquid crystals, rotating polarizers, polarization rotators Pi cells, and combinations thereof.

25. The system of claim 22, wherein the first and third encoding means are at least one of an a reflector or mirror, an achromatic filter, a chromatic filter, an anaglyphic filter, a polarizing filter, a retarder, an occluder, a rotating polarizer, a polarization rotator, and a shutter.

26. The system of claim 22, wherein in the first mode the first, second, and third encoding means are in the optical path and in the second mode at least one of the first, second, and third encoding means are not in the optical path.

27. The system of claim 22, wherein the at least one optical characteristic is polarization, in the first mode the polarization orientations of the second and third signal portions are transverse and in the second mode the polarization orientations of the second and third signal portions are at least substantially parallel.

28. The system of claim 27, wherein the second encoding means is at least one of transversely oriented wave retarders, transversely oriented polarization retarders, and alternately energized polarization retarders.

29. The system of claim 28, wherein the at least one of transversely oriented wave retarders, transversely oriented polarization retarders, and alternately energized polarization retarder are in an at least substantially non-overlapping relationship.

30. The system of claim 22, wherein the polarization orientations of the first and third encoding means are one of at least substantially parallel, orthogonal, and offset by 45 degrees.

31. The system of claim 22, wherein the at least a second encoding means is passive and the third encoding means comprises at least two retarders and further comprising signal directing means for directing the second and third imaging signal portions along spatially distinct second and third optical paths, respectively, wherein at least one retarder is positioned along each of the second and third optical paths.

32. A light valve, comprising:
a first region configured to transmit at least about 75% of at least a first wavelength of the light contacting the first region or to occlude at least about 75% of at least a first wavelength of the light contacting the first region; and
a second region, the second region comprising a plurality of first subregions spatially distributed in at least a second subregion, wherein the first subregions are transmissive or opaque and the second subregion is the other of transmissive or opaque.

33. The light valve of claim 32, wherein the first region is at least substantially uniformly transmissive or occlusive of light contacting the first region.

34. The light valve of claim 32, wherein the first and second regions each cover from about 25% to about 75% of a common light contacting surface of the light valve.

35. The light valve of claim 32, wherein the area of the first subregions ranges from about 15% to about 85% of the area of the second subregions.

36. The light valve of claim 32, wherein at least one of the first and second subregions comprises a liquid crystal material bounded by dikes, both of which are positioned between optically transmissive plates and in contact with a pair of electrodes.

37. The light valve of claim 32, wherein at least one of the first and second subregions comprises an optical retarding material sandwiched between opposing optically transmissive plates.

38. The light valve of claim 32, wherein the area of the first region is from about 25% to about 75% of the area of the light contacting surface of the light valve.

39. A method for encoding an optical signal, comprising:
providing at least first, second, third and fourth optical regions, wherein the at least first, second, third and fourth optical regions are in an at least substantially non-overlapping relationship, at least the first and second regions have variable optical transmissivity, and the third and fourth optical regions are configured to have differing optical transmission characteristics;
in a first time interval, energizing the first region while at least one of de-energizing and reversely energizing the second region;
in a second, later time interval, energizing the second region while at least one of de-energizing and reversely energizing the first region.

40. The method of claim 39, wherein the third and fourth regions each have variable optical transmissivity and in the first time interval the third and fourth regions are at least one of de-energized and reversely energized and further comprising:
in a third, later time interval, energizing the third region while at least one of de-energizing and reversely energizing the first, second and fourth regions; and
in a fourth, later time interval, energizing the fourth region while at least one of de-energizing and reversely energizing the first, second, and third regions.

41. The method of claim 40, wherein each of the first, second, third, and fourth regions comprise a liquid crystal material.

42. The method of claim 39, wherein the first and second regions each comprise a liquid crystal material, the third region comprises an optically transmissive material, and fourth region comprises an optically occlusive material.

43. A light valve, comprising:
at least first, second, third and fourth optical regions, wherein the at least first, second, third and fourth optical regions are in an at least substantially non-overlapping relationship, at least the first and second regions have variable optical transmission characteristics, and the third and fourth optical regions are configured to have differing optical transmission characteristics.

44. The light valve of claim 43, wherein the first and second optical regions comprise a liquid crystal material, the third optical region comprises an optically transmissive material, and the fourth optical region comprises an optically occlusive material.

45. A light valve, comprising:
a first region configured to transmit at least about 75% of at least a first wavelength of the light contacting the first region or to occlude at least about 75% of the at least a first wavelength of the light contacting the first region; and
a plurality of second subregions, the second subregions being spatially distributed in the first region, wherein the second subregions are transmissive or opaque and the second subregion is the other of transmissive or opaque.

46. The light valve of claim 45, wherein the second subregions each comprise a liquid crystal material bounded by one or more dikes, both of which are positioned between optically transmissive plates and in contact with a pair of electrodes.

47. A stereoscopic optical system, comprising:
at least a first encoder configured to encode from about 45% to about 80% of a received imaging signal to form a first encoded imaging signal and an unencoded imaging signal and
at least a second encoder configured to encode at least about 80% of the first encoded and unencoded imaging signals to form a second encoded imaging signal.

48. The optical system of claim 47, wherein the at least a first encoder comprises at least first and second encoder portions and wherein the first encoder portion has a polarization orientation that is transverse to a polarization orientation of the second encoder portion.

49. The optical system of claim 47, further comprising:
at least a third encoder configured to encode from about 45% to about 80% of the second encoded imaging signal to form a third encoded signal and a fourth unencoded imaging signal.

50. The optical system of claim 49, wherein the at least a third encoder comprises at least first and second encoder portions and wherein the first encoder portion has a polarization orientation that is at least substantially parallel to a polarization orientation of the second encoder portion.

51. The optical system of claim 49, wherein the at least a first and third encoders have the same shape, are positioned on either side of the at least a second encoder, and at least substantially overlap one another in the optical path.

52. The optical system of claim 47, wherein the at least a second encoder is positioned at or near an aperture stop and/or conjugate thereof.

53. The optical system of claim 47, further comprising:
a signal director configured to direct a first imaging signal portion of the second encoded imaging signal along a first optical path and a second imaging signal portion of the second encoded imaging signal along a spatially offset second optical path;
at least a first polarizer configured to filter the first imaging signal portion to form a filtered first imaging signal portion; and
at least a second polarizer configured to filter the second imaging signal portion to form a filtered second imaging signal portion.

54. A stereoscopic optical system, comprising:
a primary encoder configured to encode at least about 80% of an imaging signal to form an encoded imaging signal; and
an analyzing encoder configured to encode further from about 45% to about 80% of the encoded imaging signal to form output first and second imaging signals.

55. The optical system of claim 54, further comprising:
a leading first encoder configured to encode from about 45% to about 80% of a received imaging signal to form the imaging signal, the imaging signal comprising encoded and unencoded imaging signal portions.

56. The optical system of claim 55, wherein the leading first encoder comprises at least first and second encoder portions and wherein the first encoder portion has a polarization orientation that is transverse to a polarization orientation of the second encoder portion.

57. The optical system of claim 54, wherein the analyzing encoder comprises at least first and second encoder portions and wherein the first encoder portion has a polarization orientation that is at least substantially parallel to a polarization orientation of the second encoder portion.

58. The optical system of claim 55, wherein the leading and analyzing encoders have the same shape, are positioned on either side of the primary encoder, and at least substantially overlap one another in the optical path.

59. The optical system of claim 58, wherein the primary encoder is located at or near an aperture stop and/or conjugate thereof.

60. An iris for an optical system, comprising:
a transmissive micro-display comprising a plurality of pixels, each of the plurality of rectangular pixels being independently switchable between an at least substantially transmissive state and an at least substantially opaque state to provide a desired optical output.

61. The iris of claim 60, wherein each pixel comprises a liquid crystal material.

62. The iris of claim 60, wherein each pixel is operatively connected to a respective pair of electrical conductors.

63. The iris of claim 60, wherein in the at least substantially transmissive state a pixel passes at least about 75% of light of one or more wavelengths contacting the pixel and in the at least substantially opaque state the pixel passes no more than about 25% of light of the one or more wavelengths contacting the pixel.

64. The iris of claim 60, wherein the transmissive micro-display has a pixel density of at least about 1024 pixels/cm².

65. The iris of claim 60, wherein each pixel in the plurality of pixels is configured to be switched between the transmissive and opaque states in a time of no more than about 8 milliseconds.

66. A method for controlling optical output of an optical system, comprising:
during a first time interval, energizing a first set of pixels in an iris to place the pixels in the first set of pixels in one of an optically occlusive and optically transmissive state while de-energizing or reversely energizing a mutually exclusive second set of pixels in the iris to place the pixels in the second set of pixels in the other of one of an optically occlusive and optically transmissive state to thereby define an aperture of a first size; and
during the first time interval, energizing at least a portion of an encoder to encode an imaging signal at least one of before and after the imaging signal passes through the aperture of the iris.

67. The method of claim 66, wherein each of the pixels in the first and second sets of pixels comprises a liquid crystal material.

68. The method of claim 67, wherein the liquid crystal material is bounded by one or more dikes and sandwiched between opposing optically transmissive plates.

69. The method of claim 66, wherein the plurality of pixels in the first and second sets of pixels are part of a transmissive micro-display.

70. The method of claim 66, further comprising in a second, later time interval:
energizing the second set of pixels in an iris to place the pixels in the second set of pixels in one of an optically occlusive and optically transmissive state while de-energizing or reversely energizing the first set of pixels in the iris to place the pixels in the first set of pixels in the other of one of an optically occlusive and optically transmissive state to thereby define an aperture of a second size, whereby the first size is different from the second size.

71. The method of claim 66, wherein during the first time interval a first portion but not a second portion of the encoder is energized and further comprising in a second, later time interval:
energizing the second portion but not the first portion of the encoder.

72. A method for controlling optical output of an optical system, comprising:
during a first time interval, energizing a first set of pixels in an iris to place the pixels in the first set of pixels in one of (i) a first state in which the pixel passes at least most of a first wavelength band but not at least most of a second wavelength band of light and (ii) a second state in which the pixel does not pass at least most of the first wavelength band of light while de-energizing or reversely energizing a second set of pixels to place the pixels in the second set of pixels in the other of the first and second states.

73. The method of claim 72, wherein in the second state a pixel passes at least most of the first wavelength band.

74. The method of claim 72, wherein in the second state a pixel does not pass at least most of the second wavelength band.

75. An optical system, comprising:
a lens having at least one of an aperture stop and conjugate thereof; and
an iris positioned at the aperture stop, the iris comprising a plurality of pixels, each pixel being configured to be independently switchable between a first state in which the pixel passes at least most of a first wavelength band but not at least most of a second wavelength band of light and in a second state in which the pixel passes at least most of the second wavelength band of light.

76. The optical system of claim 75, wherein the iris is a transmissive micro-display.

77. The optical system of claim 75, wherein at least part of the iris is positioned at or near at least one of an aperture stop and conjugate thereof.

78. The optical system of claim 75, wherein in the second state the pixel passes at least most of the first wavelength band of light.

79. The optical system of claim 75, wherein in the second state the pixel does not pass at least most of the first wavelength band of light.

80. The optical system of claim 75, wherein a first set of pixels is switched to the first state and a second set of pixels is switched to a second state and wherein the first set of pixels defines an aperture and the aperture is at least one of triangular, rectangular, polygonal, spherical, and elliptical.

81. A method for producing, from a received imaging signal containing image information relating to an object, a direct three-dimensional image of the object in a first mode and an inverse three-dimensional image of the object in a second mode, comprising:
receiving an imaging signal comprising information regarding an object; and
in a first operational mode, encoding the received imaging signal to form at least an encoded first imaging signal and processing the at least a first imaging signal to form a direct three-dimensional image of the object; and
in a second operational mode, encoding the received imaging signal to form at least an encoded second imaging signal and processing the at least a second imaging signal to form an inverse three-dimensional image of the object.

82. The method of claim 81, further comprising:
in a third operational mode, encoding the received imaging signal to form at least an encoded third imaging signal and processing the at least a third imaging signal to form a two-dimensional image of the object.

83. The method of claim 82, wherein in the first and third operational modes, the encoding and processing steps each comprise:
encoding the received imaging signal to form at least a first encoded imaging signal;
passing the first imaging signal through at least one encoder, positioned at or near at least one of an aperture stop and a conjugate thereof, to encode differently portions of the first encoded imaging signal and form at least second and third encoded imaging signal portions; and
further encoding the second and third encoded imaging signal portions, wherein, during a selected time interval, in a first mode the second and third encoded imaging signal portions have at least one differing optical characteristic and in a second mode the at least one differing optical characteristic of the second and third encoded signal portions is at least substantially the same.

84. The method of claim 81, wherein the optical characteristic is at least one of wavelength distribution, intensity, polarization orientation, and phase.

85. The method of claim 83, wherein the passing step comprises;
during a first time interval, at least one of energizing, de-energizing, and reversely energizing a first portion of the at least one encoder and another of the at least one of energizing, de-energizing, and reversely energizing a second, different portion of the at least one encoder; and
during a second, later time interval, at least one of energizing, de-energizing, and reversely energizing the second portion of the at least one encoder and another of the at least one of energizing, de-energizing, and reversely energizing the first portion of the at least one encoder.

86. The method of claim 83, wherein the passing step comprises;
during a first time interval, passing at least most of the second encoded imaging signal portion but not at least most of the third encoded imaging signal portion; and
during a second, later time interval, passing at least most of the third encoded imaging signal portion but not at least most of the second encoded imaging signal portion.

87. The method of claim 83, wherein in the first mode the first, second, and third encoders are in the optical path and in the second mode at least one of the first, second, and third encoders are not in the optical path.

88. The method of claim 83, wherein the at least one optical characteristic is polarization, in the first mode the polarization orientations of the second and third encoded imaging signal portions are transverse and in the second mode the polarization orientations of the second and third encoded imaging signal portions are at least substantially parallel.

89. The method of claim 83, wherein the at least one optical characteristic is intensity.

90. The method of claim 83, wherein the second and third encoded imaging signal portions are each formed from about 25% to about 50% of the first imaging signal.

91. The method of claim 83, wherein during a first selected time interval in the first mode the second encoded imaging signal portion is at least about 43.5% of the first encoded signal and the third encoded imaging signal portion is no more than about 16.5% of the first encoded signal and during a second later selected time interval in the second mode the third encoded imaging signal portion is at least about 43.5% of the first encoded signal and the second encoded imaging signal portion is no more than about 16.5% of the first encoded signal.
